(19) United States
(12) Patent Application Publication
(10) Pub. No.: US 2009/0102831 A1
(43) Pub. Date: Apr. 23, 2009

(54) Driving circuit for display apparatus

(75) Inventor: Yoshiharu HASHIMOTO, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Elpida Memory, Inc., Tokyo (JP)

(21) Appl. No.: 12/289,140

(22) Filed: Oct. 21, 2008

(30) Foreign Application Priority Data
Oct. 22, 2007 (JP) 2007-273669

(51) Int. Cl. G09G 5/00

(52) U.S. Cl. 345/214

(57) ABSTRACT

A driving circuit for a display apparatus, includes a first selecting circuit configured a to select a binary voltage from a plurality of voltages based on a image data to output to a first node as a first selection voltage and to a second node as a second selection voltage; a first buffer configured to receive the first selection voltage; and a second buffer configured to receive the second selection voltage. A voltage dividing circuit is configured to generate a plurality of interpolation voltages between an output voltage of the first buffer and an output voltage of the second buffer. A second selecting circuit is configured to select one voltage from the first selection voltage and the plurality of interpolation voltages based on a part of the image data, to output to a third node as a third selection voltage. A first control circuit is configured to control the first buffer or the second buffer based on the part of the image data.

### INCORPORATION BY REFERENCE

This application claims priority on convention based on Japanese Patent Application No. 2007-273669. The disclosure thereof is incorporated herein by reference.

### BACKGROUND OF THE INVENTION

1. Field of the Invention

The present invention relates to a driving circuit for a display apparatus and to a technique for equalizing error voltages generated in a separating/synthesizing-type D/A converter circuit or an output buffer with respect to time.

2. Description of Related Art

A matrix type display panel having pixels arranged in a matrix is one of the most typical display apparatuses. The matrix-type display panel is provided with scanning lines corresponding to rows of pixels, and data lines to which display signals (gradation voltages, gradation currents) corresponding to gradations of the pixels are supplied. The pixels are disposed at intersection points of the scanning lines and the data lines, and the pixel includes a TFT (Thin Film Transistor) as a switching element and a pixel electrode. In a liquid crystal display panel, liquid crystal fills a space between the pixel electrode and a common electrode opposing to the pixel electrode.

In the liquid crystal display panel, an inversion drive system is employed in which the polarity of a voltage to be applied to the pixel is inverted in order to suppress deterioration of liquid crystal material. In other words, the pixels are driven in an alternating current manner.

In amplitude modulation in which brightness (transmittance of light) is controlled in a plurality of gradation voltages, the number of D/A converter circuits increases in accordance with the increase of the number of bits of image data. For this reason, a separating/synthesizing-type D/A converted circuit is known which divides image data into upper bits and low bits, described in Japanese Patent Application Publication (JP-A-Heisei 9-258695).

In the Japanese Patent Application Publication (JP-A-Heisei 9-258695), a first selecting circuit selects a first voltage and a second voltage from a plurality of voltages according to an upper image data. A voltage dividing circuit generates a plurality of interpolation voltages as voltages between the first voltage and the second voltage. A second selecting circuit selects a single voltage form the plurality of interpolation voltages according to a lower bit portion of the image data. A first buffer receiving a first voltage and a second buffer receiving a second voltage are provided between the first selecting circuit and the voltage dividing circuit.

A reason why the first and second buffers are provided is to prevent an output voltage from being fluctuated because of resistance dependency of switches of the first selecting circuit. The switch of the first selecting circuit includes a transfer switch of an n-type transistor and a p-type transistor, and ON-resistance of the switch varies depending on an input voltage. Another reason is in that crosstalk is caused when the numbers of output gradations are different between driver ICs.

However, it is not possible to obtain a monotonous increase characteristic if error voltages of the first buffer and the second buffer are extensive. Further, consumed power increases due to operation currents of the first buffer and the second buffer.

### SUMMARY

In an aspect of the present invention, a driver circuit for a display apparatus, includes a first selecting circuit configured a to select a binary voltage from a plurality of voltages based on a image data to output to a first node as a first selection voltage and to a second node as a second selection voltage; a first buffer configured to receive the first selection voltage; and a second buffer configured to receive the second selection voltage. A voltage dividing circuit is configured to generate a plurality of interpolation voltages between an output voltage of the first buffer and an output voltage of the second buffer. A second selecting circuit is configured to select one voltage from the first selection voltage and the plurality of interpolation voltages based on a part of the image data, to output to a third node as a third selection voltage. A first control circuit is configured to control the first buffer or the second buffer based on the part of the image data.

In the present invention, offset voltages of a first buffer and a second buffer of a separating/synthesizing-type D/A converter circuit are switched by every predetermined period. This makes it possible to obtain a monotonous increase characteristic, since display signals supplied to pixels are averaged with respect to time and brought closer to an ideal voltage. Further, even if there is gain variation in an output buffer, the display signals can be averaged with respect to time to be brought closer to the ideal voltage by switching the gain by every predetermined period. Furthermore, the error voltages of the driving circuit are dispersed spatially on the panel to suppress generation of flickers. Therefore, fine picture qualities can be obtained.

Further, when a part of the image data is predetermined data, the consumed power is reduced by shutting off the current flowing through a resistance string circuit by inactivating the first buffer or the second buffer. Further, an operation of the first switching circuit is stopped to reduce the power consumed for the switching operation.

Furthermore, the gain of the output buffer is larger than “1”, so that the voltage of the D/A converter circuit can be lowered. As a result, the power consumption and size of the D/A converter can be reduced.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a block diagram of a display apparatus;

FIG. 2 is a circuit diagram showing a driving circuit for a display apparatus according to a first embodiment of the present invention;

FIG. 3 is a circuit diagram showing details of the driving circuit in the first embodiment;

FIG. 4 is a circuit diagram showing a first control circuit in the driving circuit in the first embodiment;

FIG. 5 is a voltage diagram showing that an interpolation voltage generated by a D/A converter circuit of the driving circuit is an ideal voltage theoretically;

FIG. 6 is a diagram showing a transmittance-voltage characteristic of liquid crystal;

FIG. 7 is a diagram schematically showing a switching state of an offset voltage and a polarity of a pixel in the first embodiment;

FIGS. 8A to 8D are timing charts for the operations shown in FIG. 7;

FIG. 9 is a diagram schematically showing the states of pixels in the first embodiment;

FIG. 10 is a circuit diagram of an output buffer in the driving circuit according to a second embodiment of the present invention;

FIGS. 11A and 11B are circuit diagrams schematically showing a gain controlling operation of the output buffer in the second embodiment;

FIGS. 12A and 12B are circuit diagrams schematically showing a gain controlling operation of the output buffer in the second embodiment;

FIG. 13 is a circuit diagram showing the driving circuit according to a third embodiment of the present invention;

FIGS. 14A and 14B are diagrams showing a relation between image data and display signals according to the third embodiment;

FIG. 15 is a circuit diagram showing a gradation voltage generating circuit in the driving circuit according to the third embodiment;

FIG. 16 is a diagram schematically showing the display state of pixels according to the third embodiment;

FIGS. 17A to 17I are timing chart of various signals in the states shown in FIG. 16;

FIG. 18 is a diagram schematically showing the display state of pixels in a 2H dot inversion drive in the third embodiment;

FIG. 19 is a diagram schematically showing the display state of pixels in a column inversion drive in the third embodiment;

FIG. 20 is another circuit diagram showing the output buffer of the driving circuit in the third embodiment;

FIGS. 21A and 21B are diagrams showing input/output characteristics of the output buffer in the third embodiment;

FIG. 22 is a circuit diagram of the driving circuit according to a fourth embodiment of the present invention;

FIG. 23 is circuit diagram showing the driving circuit according to a fifth embodiment of the present invention;

FIG. 24 is a graph showing a luminance-gradation characteristic of an organic EL;

FIG. 25 is a table showing a relation between image data and output voltage on a third node;

FIG. 26 is a graph showing a transmittance-voltage characteristic of a liquid crystal;

FIG. 27 is a circuit diagram showing the configuration of a gradation voltage generating circuit of the driving circuit in a modification of the present invention; and

FIG. 28 is a diagram showing a connection state of wirings of a master IC and a slave IC.

### DESCRIPTION OF THE PREFERRED EMBODIMENTS

Hereinafter, a driving circuit which is applied to a display apparatus of the present invention will be described with reference to the attached drawings. It should be noted that same or similar reference numerals are applied to same or similar components in the drawings. Further, a plurality of same components are identified with suffixes applied as necessary. However, the suffixes are omitted when it is unnecessary to identify those components from each other.

### First Embodiment

FIG. 1 is a block diagram of a display apparatus 100. The display apparatus 100 includes a display panel 1, a scanning line driving circuit 2, and a data line driving circuit 3 at least. On the display panel 1, a plurality of scanning lines 4 are arranged in a row direction, and a plurality of data lines 5 are arranged in a column direction. Pixels 6 are disposed at intersection points between the scanning lines 4 and the data lines 5. Although not shown, each pixel 6 includes a TFT element, a pixel electrode, and a common electrode opposing to the pixel electrode. Liquid crystal material or organic EL material fills a space between the pixel electrode and the common electrode. Further, the data line driving circuit 3 supplies a display signal (gradation voltage) to each data line according to image data, and the gradation voltage corresponding to the image data is written into each pixel on the scanning line that is activated by the scanning line driving circuit 2.

In a small-sized liquid crystal display panel, the data line driving circuit 3 is integrated on a single semiconductor chip (driver IC), and it is mounted on the display panel 1 in which the pixels are formed. The scanning line driving circuit 2 in many cases is formed on a driver IC where the data line driving circuit 3 is integrated, or formed on the display panel 1. In a large-sized liquid crystal display panel, it is difficult to integrate all the data line driving circuits on a single IC driver since there are a large number of pixels. Normally, a plurality of driver ICs are used. A driver output terminal X is connected to the data line 5 via an anisotropic conductive film (ACF).

In the liquid crystal display panel, a positive-polarity gradation voltage and a negative-polarity gradation voltage with respect to a voltage (Vcom) of the common electrode are alternately supplied to the pixel electrode of each pixel 6 for every frame. In the following description, it is described as “inversion of the polarity of a pixel” in short. Also, the positive-polarity gradation voltage and the negative-polarity gradation voltage with respect to the common electrode voltage “Vcom” are expressed as “+” and “−”, respectively. A driving method in which the polarity of the common electrode voltage “Vcom” is inverted for every scanning line is referred to as a line inversion drive method, and a driving method in which the polarity of the common electrode voltage “Vcom” is inverted for every frame is referred to as a frame inversion drive method. In a fixed state of the common electrode voltage “Vcom”, a driving method in which the polarities of the gradation voltages are different between adjacent data lines for every scanning line is referred to as a dot inversion drive method, and a driving method in which the polarities of the gradation voltages are different between adjacent data lines for every frame is referred to as a column inversion drive method. The present embodiment will be described by using the line inversion drive method as an example. “One frame” includes the scanning lines from the top to the bottom. In case of interlace scanning, one frame is divided into an odd field and an even field.

In the present invention, it is supposed that image data for one pixel is composed of N bits of (N−M) bits as an upper bit portion and M bits as a lower bit portion (M and N are natural numbers). Also, a K bit portion of the upper bit portion including the MSB is referred to as an upper K-bit portion (K is a natural number and satisfies K<N−M). Also, the image data is expressed in hexadecimal notation. Here, “00000000” is expressed as “00h”, and “11111111” is expressed as “FFh”. In the following description, a case of N=8, M=2 and K=3 is supposed. The image data is assumed to be of eight bits (D7, D6, D5, D4, D3, D2, D1, D0), and the most significant bit (MSB) is D7, and the least significant bit (LSB) is D0. Further, a driving circuit for a single output will be described in order to simplify the description.

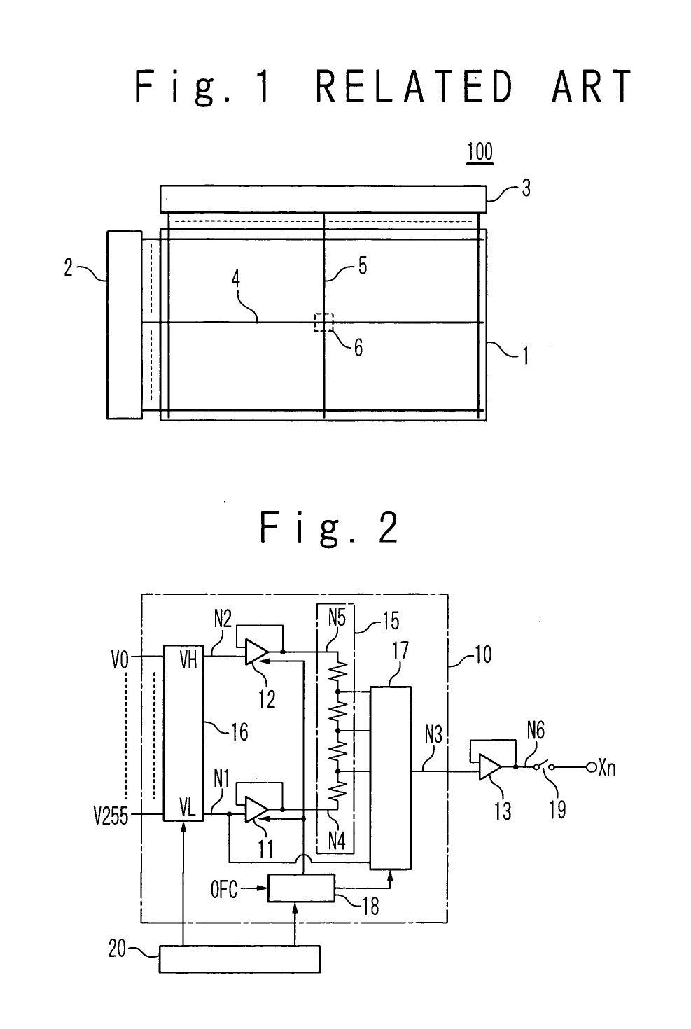

FIG. 2 is a circuit diagram showing a digital-to-analog (D/A) converter circuit 10 included in a driving circuit of the display apparatus according to a first embodiment of the present invention. The driving circuit according to the first embodiment includes the D/A converter circuit 10, a data latch circuit 20, and a driver output terminal X. In addition, an output buffer 13, and an output switch 19 are also integrated on a driver IC, as well as a shift register circuit, a data register circuit, a level shift circuit, a gradation voltage generating circuit, and a power supply circuit as well known, although being not shown.

The D/A converter circuit 10 is a separating/synthesizing-type D/A converter circuit, which includes a first selecting circuit 16, a first buffer 11, a second buffer 12, a resistance string circuit 15, a second selecting circuit 17, and a first control circuit 18. The D/A converter circuit for driving the data line of the display apparatus is required to have a monotonous increase characteristic and a small voltage variation.

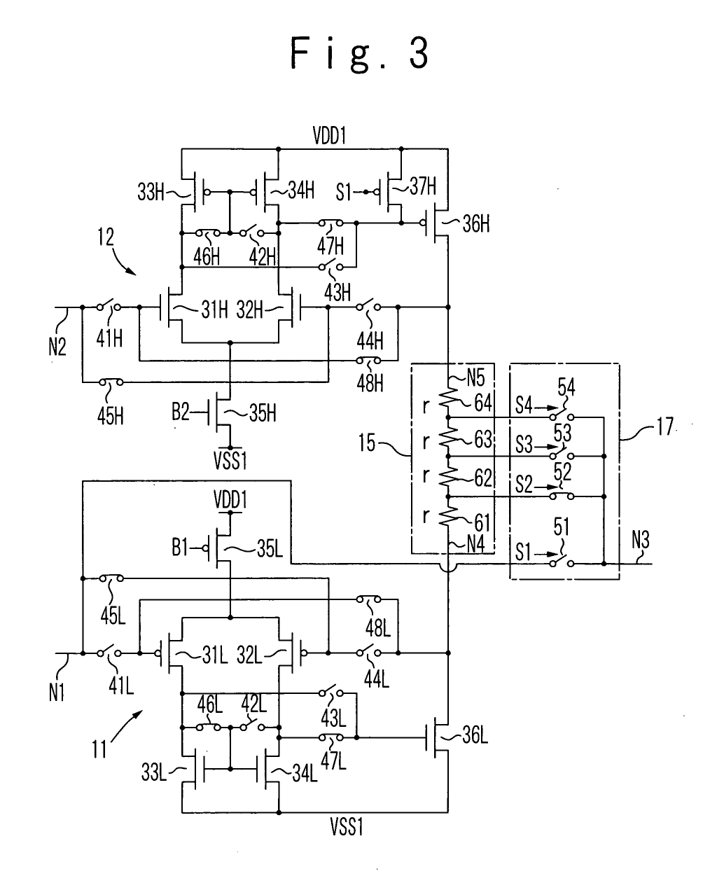

FIG. 3 is a circuit diagram showing details of the first buffer 11, the second buffer 12, the resistance string circuit 15, and the second selecting circuit 17 of the D/A converter circuit 10. Referring to FIGS. 2 and 3, a plurality of voltages (V0 to V255) are generated by a gradation voltage generating circuit and are supplied to the first selecting circuit 16. The first selecting circuit 16 selects two voltages from the plurality of voltages (V0-V255) in accordance with image data latched to the data latch circuit 20, outputs the selected voltages to a first node N1 as a first selection voltage VL, and to a second node N2 as a second selection voltage VH. The first selection voltage is supplied to a first buffer 1, and the second selection voltage is supplied to a second buffer 12.

The first buffer 11 is a voltage follower in which an offset voltage can be changed. The offset voltage is changed by switching switches 41L to 44L and 45L to 48L in a first switching circuit. Through the switching operation, a transistor 31L of a differential pair section functions as one of a non-inversion input terminal and an inversion input terminal, and a transistor 32L of the differential pair section functions as the other. For example, in an A state, the switches 41L to 44L are in an OFF state and the switches 45L to 48L are in an ON state. It is supposed that the offset voltage in the A state is “+e1”. In a B state, the switches 41L to 44L are in the ON state and the switches 45L to 48L are in the OFF state. At this time, the offset voltage in the B state is “−e1”.

Like the first buffer 11, the second buffer 12 is also a voltage follower in which the offset voltage can be changed. The offset voltage is changed by switching switches 41H to 44H and 45H to 48H in the first switching circuit. Through the switching operation, a transistor 31H of a differential pair section functions as one of a non-inversion input terminal and an inversion input terminal, and a transistor 32H of the differential pair section functions as the other. For example, in the A state, the switches 41H to 44H are in the OFF state and the switches 45H to 48H are in the ON state. In this case, it is supposed that the offset voltage in the A state is “−e2”. In the B state, the switches 41H to 44H are in the ON state and the switches 45H to 48H are in the OFF state. In this case, the offset voltage in the B state is “+e2”. In this way, because polarities of the offset voltages are inverted, it is described as “inversion of the polarity of the offset voltage” to change the offset voltages of the first buffer 11 and the second buffer 12. Further, it is supposed that the first switching circuit takes one of the A state and the B state.

The resistance string circuit 15 includes a plurality of resistances 61 to 64 connected in series. One terminal of the resistance string circuit 15 as a fourth node N4 is connected to an output terminal of the first buffer 11, and the other terminal thereof as a fifth node N5 is connected to an output terminal of the second buffer 12. The resistance string circuit 15 generates a plurality of interpolation voltages in a voltage range between an output voltage of the first buffer 11 and an output voltage of the second buffer 12. Ideal interpolation voltages are “VL+(VH−VL)/4”, VL+2(VH−VL)/4, and “VL+3(VH−VL)/4”. Resistance values r of the respective resistances are designed to be same. The phrase “designed to be same” means that although the values are designed to be same, several % of relative error actually exits due to manufacture variation. Accordingly, it is extremely rare to have the same values.

A voltage difference between an ideal output voltage and an output voltage from the D/A converter circuit or the output buffer is referred to as an error voltage. In the D/A converter circuit 10, the error voltages are generated due to offset voltage variation and gain variation in the first and second buffers 11 and 12, and generated due to resistance variation in the resistance string circuit 15. Since the first buffer 11 and the second buffer 12 are voltage followers (gain=1) so that there is almost no variation in the gain, the “error voltage≈offset voltage”. In the output buffer, the error voltages are generated due to the offset voltage variation, and generated due to the gain variation.

As a method of canceling the offset voltage of the buffer, there are a digital method and an analog method. In the digital method, A/D conversion is performed on the offset voltage of the buffer so as to store it as a digital correction data, which is added to the digital input image data in a digital manner. In the analog method, the offset voltage of the buffer is stored in a capacitance, which is added to the input gradation voltage in an analog manner. The digital method requires a circuit for storing the digital correction data and a circuit for calculating the digital data, thereby increasing a circuit scale. The analog method has such an issue that the voltage is varied due to leakage currents of the capacitance and the switch, as well as a switching noise.

In the present embodiment, the polarity of the offset voltage is inverted to average the offset voltages with respect to time so as to cancel the error voltage of the D/A converter circuit. Referring to FIG. 5, it is described that an interpolation voltage generated by the D/A converter 10 is the ideal voltage theoretically. As described in the example above, it is assumed that the first buffer 11 has the offset voltage “+e1” and the second buffer 12 has the offset voltage “−e2” in the A state, while the first buffer 11 has the offset voltage “−e1” and the second buffer has the offset voltage “+e2” in the B state. When the two lower bits are “01”, the voltage in a connection point between the resistance 61 and the resistance 62 is selected, and the voltage at that time is expressed by the equation (1) in the A state, and by the equation (2) in the B state.

Va=(VL+e1)+{(VH−e2)−(VL+e1)}/4 (1)

Vb=(VL−e1)+{(VH+e2)−(VL−e1)}/4 (2)

(Va+Vb)/2 (3)

The average voltage is obtained from the equation (3). By substituting the equation (1) and the equation (2) to the equation (3), an equation of “VL+(VH−VL)/4” is obtained. This is the ideal voltage mentioned above. This is similar when the two lower bits are “10” or “11”. This can be expressed in an illustration of FIG. 5 in which the solid line (ideal voltage) is obtained by averaging the dotted line and the alternate long and short dash line.

Returning to FIG. 3, the second selecting circuit 17 includes four switches 51 to 54. Of the four switches 51 to 54, the switches 52, 53, and 54 except for the switch 51 are connected to the connection points of the resistances of the resistance string circuit 15, and the interpolation voltages are supplied thereto. The switch 51 is provided between the first node N1 and the third node N3. The four switches 51 to 54 are controlled in such a manner that one of these switches is turned ON in accordance with the two lower bits (D1, D0) of the image data including the least significant bit (D0), and the selected voltage corresponding to the turned-on switch is outputted to the third node N3 as a third selection voltage. The switch 51 is turned ON in accordance with the two lower bits of the image data, when the two lower bits are “00”, the switch 52 is turned ON when “01”, the switch 53 is turned ON when “10”, and the switch 54 is turned ON when “11”. In case of the image data with which the switch 51 is selected, error voltages generated in the first buffer 11, the second buffer 12, and the resistance string circuit 15 are not included. In the present embodiment, the resistance string circuit 15 and the second selecting circuit 17 includes four resistances 61 to 64 and four switches 51 to 54 since the two lower bits of the image data are used. However, the number of bits is not limited to two, and a single bit or three or more bits may be used. When the three bits are used, eight resistances and eight switches may be provided (2³=8), and when four lower bits are used, sixteen resistances and sixteen switches may be provided (2⁴=16).

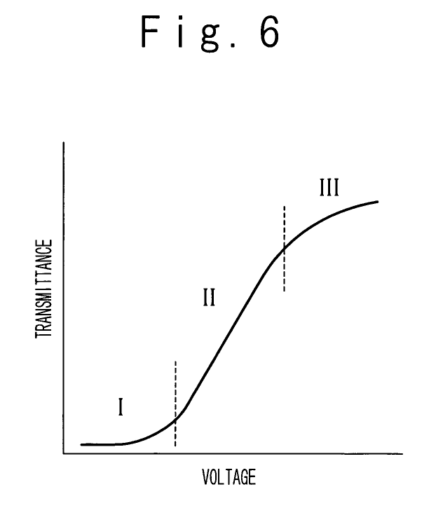

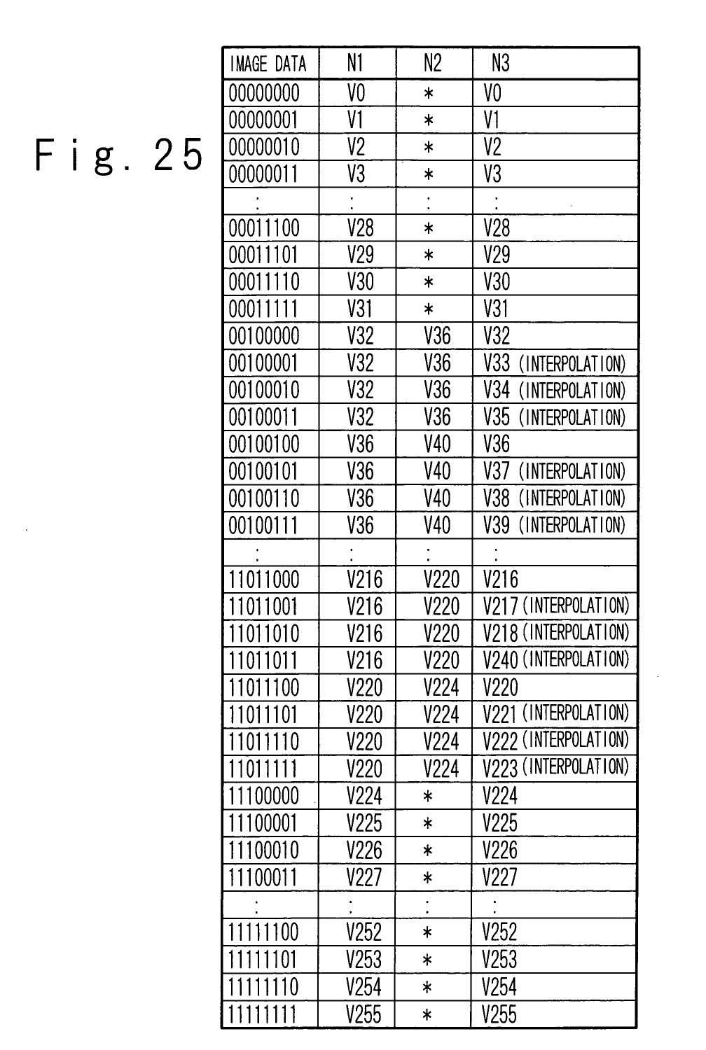

FIG. 25 shows a relation between the image data and the voltage outputted to the third node N3. A transmittance-voltage characteristic of the liquid crystal display panel is in a non-linear form, so that it is classified into three regions of region I, region II, and region III, as shown in FIG. 6. The region I and the region III are non-linear (saturated) regions, and the voltage intervals are not constant with respect to the transmittance. Thus, any interpolation voltages are not selected, and the switch 51 is turned ON to output the selected one of the voltages V0, V1, . . . , V30, V31, V224, V225, . . . , V254, V255 to the third node N3 directly. Whether the region is the saturated region or the linear region is determined based on the three higher bits (D7, D6, D5) of the image data including the most significant bit (D7). When the three higher bits are “000” or “111”, it is determined as the saturated region. The region II is the linear region, and a selected one of the voltages of V32, V36, . . . , V116, V220, or one of the interpolation voltages is outputted to the third node N3. For example, when the adjacent two voltages selected by the first selecting circuit 16 are V32 and V36, the ideal voltages of the interpolation voltages are “V33=V32+(V36−V32)/4”, “V34=V32+2(V36−V32)/4”, and “V35=V32+3(V36−V32)/4”.

The gradation voltages other than the above-described interpolation voltage are generated by the gradation voltage generating circuit (not shown). A plurality of reference voltages are supplied to the gradation voltage generating circuit, and the plurality of reference voltages are divided by a resistance string circuit to generate desired gradation voltages. The gradation voltage generating circuit generates 32 gradation voltages of V0, V1, . . . , V30, V31 of the region I, 48 gradation voltages of V32, V36, . . . , V116, V220 of the region II, and 32 gradation voltages V234, V225, . . . , V254, V255 of the region III. In a large-sized liquid crystal display panel, the reference voltages are generated outside the driver IC in the most cases. Meanwhile, all the reference voltages are generated from the power supply voltages supplied to the driver IC in small-sized liquid crystal display panels.

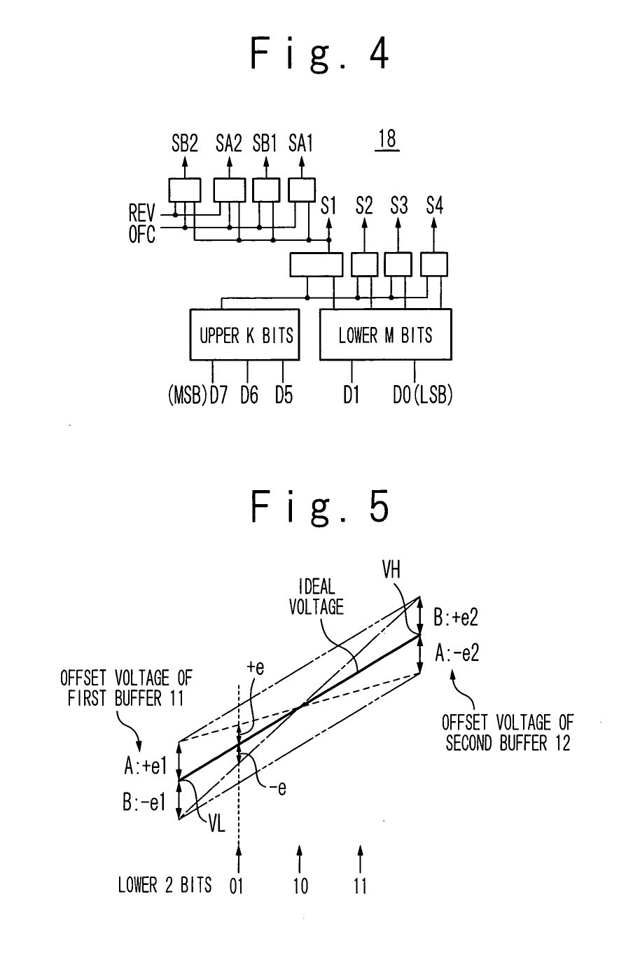

FIG. 4 is a circuit diagram showing the first control circuit 18. The first control circuit 18 controls the first buffer 11, the second buffer 12, and the second selecting circuit 17. The three higher bits (D7, D6, D5) of the image data and the two lower bits (D1, D0) are supplied to the first control circuit 18, and the first control circuit 18 outputs signals S1, S2, S3, and S4. Further, the first control circuit 18 receives an offset voltage control signal OFC (to be referred to as a signal OFC in short, hereinafter), an inversion signal REV, and a signal SA1, and generates signals SA1, SB1, SA2, and SB2.

The switches 41L, 42L, 43L, and 44L of the first switching circuit in the first buffer 11 are controlled in response to the signal SA1. The switches 45L, 46L, 47L, and 48L of the first buffer 11 are controlled in response to the signal SB1. The switches 41H, 42H, 43H, and 44H of the second buffer 12 are controlled in response to the signal SA2. The switches 45H, 46H, 47H, and 48H of the second buffer 12 are controlled in response to the signal SB2. That is, the offset voltage of the first buffer 11 and the offset voltage of the second buffer 12 can be controlled individually. In response to the signal OFC, the state is switched between the state A in which the switches 41L to 44L and 41H to 44H are turned OFF and the switches 45L to 48L and 45H to 48H are turned ON and the state B in which the switches 41L to 44L and 41H to 44H are turned ON and the switches to 48L and 45H to 48H are turned OFF. The offset switching operation of the second buffer 12 is inverted in response to the inversion signal REV. Thus, the first switching circuit in the second buffer 12 can be set to the B state (or the A state) when the first switching circuit in the first buffer 11 is set to the A state (or the B state). Since the offset voltages of the buffers 11 and 12 can be independently controlled, the offset voltage in the interpolation voltage can be made small compared with a case of the offset voltages of the same polarity, if a control is carried out in such a manner that the polarity of the offset voltage of the buffer 11 and that of the offset voltage of the buffer 12 are different from each other. Specifically, as described above, in the A state, the offset voltage of the buffer 11 is +e1 of a positive polarity, and the offset voltage of the buffer 12 is −e2 of a negative polarity. The interpolation voltage in the A state is shown by a dot line. In the B state, the offset voltage of the buffer 11 is −e1 of the negative polarity and the offset voltage of the buffer 12 is +e2 of the positive polarity. The interpolation voltage in the B state is shown by an alternate long and short dash line. The interpolation voltage when the offset voltages have the same polarity is shown by an alternate long and two short dashes line. Apparently, there are the dot line and the alternate long and short dash line between the two alternate long and two short dashes line, and the interpolation voltage is small. If e1=e2, the offset voltage of the interpolation voltage is zero in case of two lower bits of “10”.

When the two lower bits are “00”, the signal S1 is activated to turn ON the switch 51, and when “01”, the signal S2 is activated to turn ON the switch 52. When “10”, the signal S3 is activated to turn ON the switch 53, and when “11”, the signal S4 is activated to turn ON the switch 54. Further, when the three higher bits are “000” or “111”, the signal S1 is activated regardless of the two lower bits to turn ON the switch 51. Furthermore, when the signal S1 is activated, a transistor 37H which is connected between a source electrode and a gate electrode in an output. transistor 36H of the second buffer 12 is turned ON, so that the output transistor 36H is turned OFF, and current flown through the resistance string circuit 15 is shut off. Further, when all the switches 41L to 48L and 41H to 48H of the first switching circuit in the first buffer 11 and the second buffer 12 are turned OFF, the switching operation is stopped, to reduce the power consumed due to the offset voltage switching operation. In order to shut off the current flowing through the resistance string circuit 15, at least the output transistor 36H of the second buffer 12 or the output transistor 36L of the first buffer 11 are turned OFF. Furthermore, the consumed power can be reduced further by shutting off bias currents flowing through the transistor 35L and the transistor 35H.

When the first selecting circuit 16 selects the first selection voltage VL and the second selection voltage VH in such a manner that the first selection voltage VL is always smaller than the second selection voltage VH, the first buffer 11 may be a reducing-only amplifier and the second buffer 12 may be an increasing-only amplifier. As shown in FIG. 3, there is no element connected to a higher power supply voltage VDD1 in an output stage of the first buffer 11, and there is no element connected to a lower power supply voltage VSS1 in an output stage of the second buffer 12. Thus, the numbers of elements of the first buffer 11 and the second buffer 12 can be reduced, so that the size thereof and the consumed power can be reduced.

Next, a route of the electric current flowing through the resistance string circuit 15 will be described. The current flows through a route of the higher power supply voltage VDD1→the transistor 36H→the resistance string circuit 15→the transistor 36L→a lower power supply voltage VSS. Input impedances of the first buffer 11, the second buffer 12, and the output buffer 13 are extremely large and are equivalently capacitances. Thus, in a stable state, “current Istr flowing through the resistance string circuit 15=current flowing through the transistor 36H=current flowing through the transistor 36L”. Supposing that a total resistance value of the resistance string circuit 15 is “Rstr”, the current can be expressed by the following equation:

Istr=(VH−VL)/Rstr

Provided that an ON resistance value of each of the switches 51 to 54 is “Ron” and a capacitance value in the third node N3 is “Cn3”, a time constant “τ” of an intermediate voltage “{VL+½(VH−VL)}” can be expressed by the following equation:

τ=(Rstr/2+Ron)×Cn3

In case of a large-sized liquid crystal display panel, an output buffer is provided between the third node N3 and the driver output terminal. In order not to cause display unevenness due to waveform dullness, it is preferable to set the time constant to be equal to or less than “τ=1/(one horizontal synchronization period)”. In case of a small-sized liquid crystal display panel, no output buffer is necessary. In case of QGVA (240 RGB×320 pixels), one horizontal synchronization period is about 50 μsec, and a parasitic capacitance of the data line is as small as about 20 pF. Provided that “τ=5 μsec” and “Cn3=20 pF”, the following relation is satisfied:

(Rstr/2+Ron)=5 μsec/20 pF=250 KΩ

When a sum of the parasitic resistance of the data line, the ON resistance of the output switch 19, and the ON resistance of the second selecting circuit 17 is set to 200 KΩ, the following relation can be obtained: Rstr=100 KΩ “VH−VL” is about 50 mV at the maximum, so that the current “Istr” flowing through the resistance string circuit 15 is about 0.5 μA (Istr=50 mV/100 KΩ).

As described above, when a part of the image data is the above-mentioned prescribed data, the D/A converter circuit 10 turns ON the switch 51 that directly connects the third node N3 to the first node N1 from which the first selection voltage is outputted. At the same time, the D/A converter circuit 10 shuts off the current flowing through the resistance string circuit 15 by turning OFF the output transistor 36L of the first buffer 11 or the output transistor 36H of the second buffer 12 to stop the offset voltage switching operation. Thus, the consumed current due to the switching operation can be reduced. In addition, the error voltage is not included since the first buffer 11 and the second buffer 12 do not contribute.

Further, even if a part of the image data is data other than the prescribed data, the interpolation voltages represent the ideal voltages when the interpolation voltages are averaged with respect to time by inverting the polarities of the offset voltages of the first buffer 11 and the second buffer 12 are the ideal voltages. Thus, the relation of the first selection voltage VL and the plurality of interpolation voltages represents a monotonous increase characteristic.

In the present embodiment, the output buffer 13 is a voltage follower whose non-inversion input terminal is connected to the third node N3 and an inversion input terminal is connected to an output terminal. The output buffer 13 generates an offset voltage e3. When a single data line is driven by a single buffer, the offset voltage of the output buffer 13 is cancelled by averaging a positive-polarity voltage and a negative-polarity voltage. For example, when the positive-polarity voltage supplied to the output buffer 13 is “Vp”, the voltage outputted from the output buffer 13 is “Vp+e3”. Further, when the negative-polarity voltage supplied to the output buffer 13 is “Vn”, the voltage outputted from the output buffer 13 is “Vn+e3”. If the common electrode voltage “Vcom” upon application of the positive-polarity voltage is “Vcp” and the common electrode voltage “Vcom” upon application of the negative-polarity voltage is “Vcn”, a mean voltage supplied to the pixel can be expressed by the following equations (4) and (5):

{(Vp+e3)−Vcp+Vcn−(Vn+e3)}/2 (4)

=(Vp−Vcp+Vcn−Vn)/2 (5)

According to the equation (5), the offset voltage e3 of the output buffer 13 is cancelled theoretically. That is, even if there is the offset voltage in the output buffer 13, it is cancelled. Thus, no correction circuit is necessary.

In order to cancel an error voltage e of the D/A converter circuit 10 and an error voltage d of the output buffer 13, gradation voltages supplied to each pixel are averaged with respect to time for four frames as one cycle. To simplify the description, it is supposed that the positive-polarity voltage supplied to the output buffer 13 and excluding the error voltage of the D/A converter circuit 10 is “Vp”, the negative-polarity voltage is “Vn”, the error voltage of the D/A converter circuit 10 in the A state is “+e”, and the error voltage of the D/A converter circuit 10 in the B state is “−e”. When the polarities of the offset voltages of the first buffer 11 and the second buffer 12 are inverted, the two positive-polarity voltages and the two negative-polarity voltages are outputted from the output buffer 13 with the error voltage d, the two positive-polarity voltages are “Vpa=Vp+e+d” and “Vpb=Vp−e+d”, and the two negative-polarity voltages are “Vna=Vn+e+d” and “Vnb=Vn−e+d”, the same equation as the equation (5) is obtained by substituting into the following equation (6) for calculating the mean voltage of the four frames. Thus, the error voltage e of the D/A converter circuit 10 and the error voltage d of the output buffer 13 are cancelled as follows:

{Vpa−Vcp}+(Vpb−Vcp)+(Vcn−Vna)+(Vcn−Vnb)}/4 (6)

As described above, even if the output voltage of a driving circuit for driving each data line varies, the display unevenness can be suppressed because the voltage applied to each pixel can be averaged by repetitively driving the data line while using four frames as one cycle. However, the error voltage of the driving circuit may be recognized as flicker when a frame frequency is small. Therefore, a technique will be described for reducing the flicker by dispersing the error voltage of the driving circuit spatially on the display panel 1.

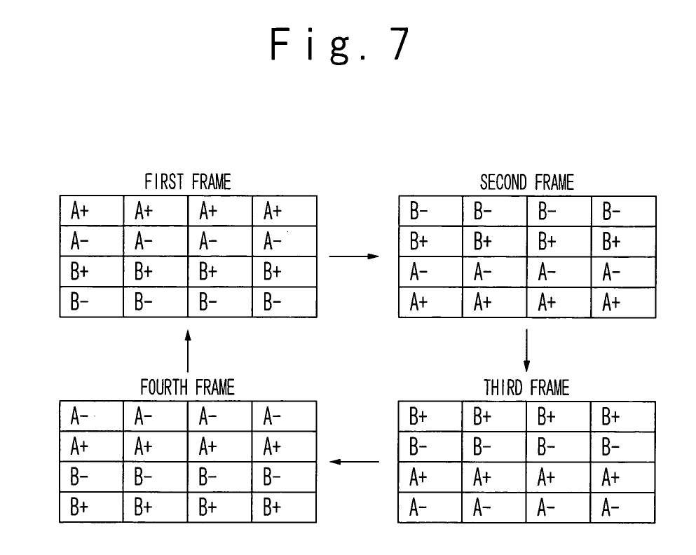

FIG. 7 is a diagram schematically showing a switching state of an offset voltage and a polarity of a pixel. “+” shown in FIG. 7 indicates that the polarity of the pixel is positive, while “−” shown in FIG. 7 indicates that the polarity of the pixel is negative. Further, “A” shown in FIG. 7 indicates that the offset voltage is in the A state, while “B” shown in FIG. 7 indicates that the offset voltage is in the B state.

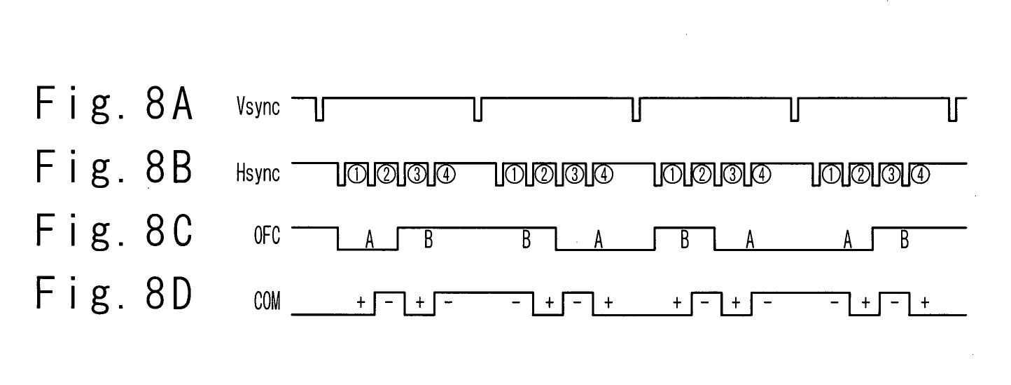

Here, it should be noted that the pixel at the i^{th} row and j^{th} column is expressed as (i, j), and a pixel on an upper-left corner is expressed as (1, 1). Further, FIGS. 8A to 8D are timing charts for the operations shown in FIG. 7. The signal OFC is inverted for every two scanning lines and every two frames. Paying attention to the pixel (1, 1), a positive-polarity voltage is supplied in a first frame, and the first switching circuit is in the A state. In a second frame, the negative-polarity voltage is supplied, and the first switching circuit is switched to the B state. In a third frame, the positive-polarity voltage is supplied, and the first switching circuit remains in the B state. In a fourth frame, the negative-polarity voltage is supplied, and the first switching circuit is switched to the A state. Hereinafter, these states are indicated as (A+, B−, B+, A−) in short. Regarding a pixel (2, 1), it is driven as in (A−, B+, B−, A+), while a pixel (3, 1) is driven as in (B+, A−, A+, B−), and a pixel (4, 1) is driven as in (B−, A+, A−, B+). In this way, the error voltage of the driving circuit is averaged with respect to time by inverting the polarity of the pixel for every frame and inverting the polarity of the offset voltage for every two frames.

Further, by inverting the polarity of the offset voltage for every two scanning lines, the error voltage is dispersed spatially. Thus, a fine image quality can be obtained. A reason why the signal OFC is inverted for every two scanning lines is that it tends to generate flicker in a lateral stripe pattern if the signal OFC is inverted for every scanning line. For example, in case of a lateral stripe pattern with white in odd-numbered (2n−1) scanning lines and gray in even-numbered (2n) scanning lines, the flickers are like to be recognized in gray on the even-numbered scanning lines since both of polarity (+, −) for the pixel electrode and for polarity of the offset voltage (A, B) are same.

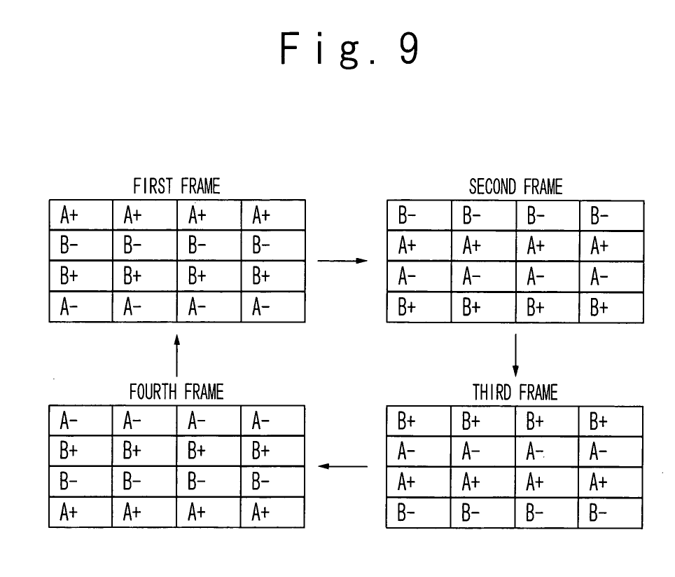

Referring to FIG. 7, in a lateral stripe pattern that white is displayed at the pixels on the odd-numbered scanning lines and gray is displayed at the pixels on the even-numbered scanning lines, the pixel (2, j) on the odd-numbered scanning line of the first frame is “A−” and the pixel (4, j) is “B−”. Thus, the polarities of the pixels are the same but the offset voltages are different in the A state and the B state. Thus, this is the same in the other frames, so that the flickers are reduced. As shown in FIG. 9, the signal OFC may be inverted for every two scanning lines with shift of one scanning line and every two frames.

The output switch 19 is provided between an output terminal N6 of the output buffer 13 and a driver output terminal Xn. The output switch 19 is turned OFF, when the output voltage from the output buffer 13 is temporarily unstable at the time of collecting the electric charges to be described later or at the time of switching the offset voltage. Needless to say, the output switch 19 is turned ON when supplying gradation voltages to the data lines 5 in accordance with the image data.

### Second Embodiment

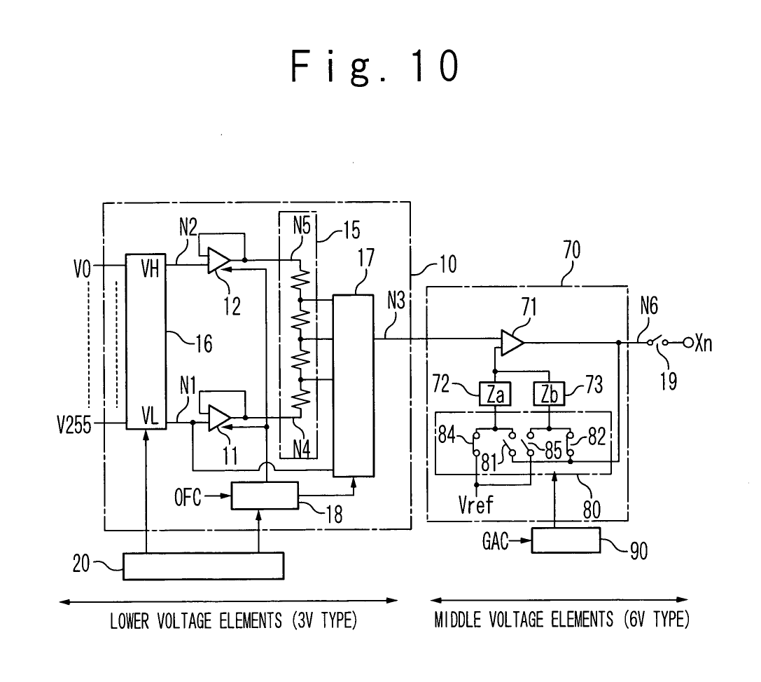

In the first embodiment, the output buffer 13 is a voltage follower. However, in a second embodiment of the present invention, an output buffer 70 is an output buffer whose ideal gain (amplification factor) is “2”. The D/A converter circuit 10 has the same circuit configuration as that of the first embodiment. Therefore, the description thereof will be omitted. The output buffer 70 will be described in details with reference to FIG. 10.

The output buffer 70 includes a differential amplifier 71, a plurality of elements 72 and 73, and a switching circuit 80. The switching circuit 80 includes a plurality of switches 81, 82, 84, 85, and the gain of the output buffer 70 can be varied by changing the connection relation of the plurality of elements. The switching circuit 80 is controlled by a second control circuit 90. It should be noted that it is not necessary to provide the second control circuit 90 for each of the driver output terminals. One second control circuit 90 or several second control circuits 90 may be provided inside the driver IC to control the switching circuits 80 of each output buffer 70 in common.

Next, a connection relation will be described. A non-inversion input terminal of the differential amplifier 71 is connected to the third node N3. An inversion input terminal of the differential amplifier 71 is connected to one end of each of the elements 72 and 73. The switch 81 and the switch 82 are respectively provided between the other end of each of the elements 72 and 73 and the output terminal N6 of the differential amplifier 71. Further, the switch 84 and the switch 85 are respectively provided between the other end of each of the elements 72 and 73 and a reference voltage line Vref.

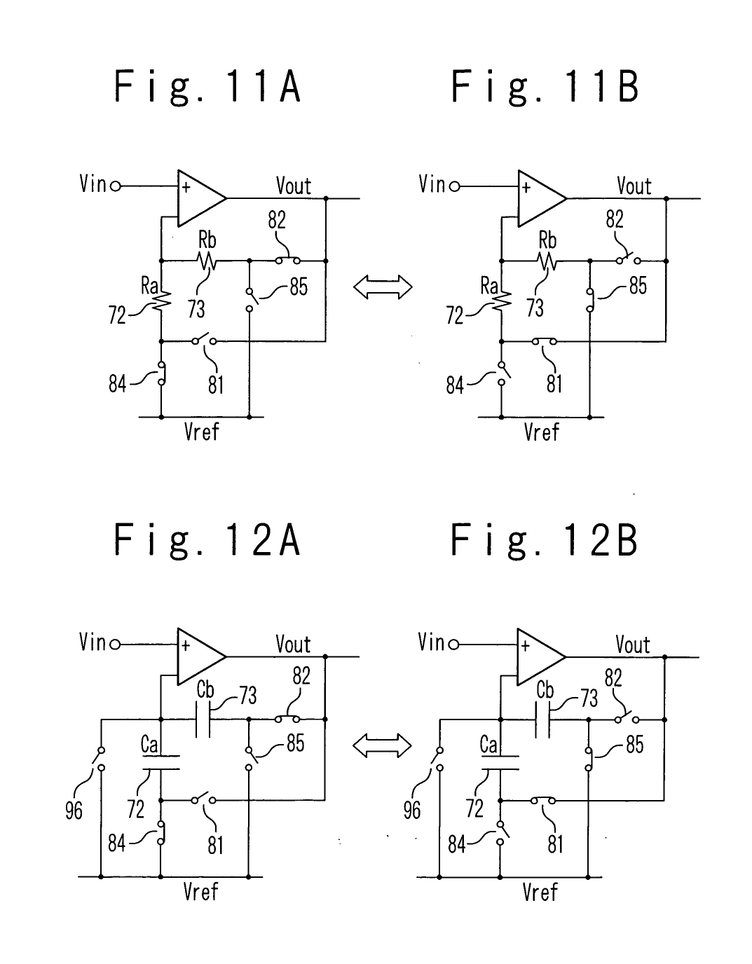

Next, an operation for controlling the gain of the output buffer 70 will be described with reference to FIGS. 11A and 11B and 12A and 12B. The elements 72 and 73 in FIGS. 11A and 11B are resistance elements, and the elements 72 and 73 in FIGS. 12A and 12B are capacitance elements. Provided that the impedances of elements are “Za” and “Zb”, replacement of “Za=Ra, and Zb=Rb” is performed in the following equations when the elements 72 and 73 are resistance elements, and the replacement of “Za=1/Ca, Zb=1/Cb” is performed when the elements 72 and 73 are capacitance elements.

If the state shown in FIG. 11A is an α state in which the switches 82 and 84 are in an ON state, and the switches 81 and 85 are in an OFF state, an input/output characteristic of the output buffer 70 can be expressed by the following equation (7):

Vout=(1+Zb/Za)Vin−(Zb/Za)Vref (7)

If the state shown in FIG. 11B is a β state in which the switches 82 and 84 are in the OFF state, and the switches 81 and 85 are in the ON state, the input/output characteristic of the output buffer 70 can be expressed by the following equation (8):

Vout=(1+Za/Zb)Vin−(Za/Zb)Vref (8)

Assuming that “α=Zb/Za”, “β=Za/Zb”, and “Vref=0 V”, the equation (7) can be expressed as in the following equation (7)′ and the equation (8) can be expressed as in the following equation (8)′.

Vout=(1+α)Vin (7)′

Vout=(1+β)Vin (8)′

It is designed as “Za=Zb”, so that the ideal characteristic is “Vout=2Vin” since “α=1” and “β=1”. Therefore, if the two states, i.e., the α state and the β state are switched periodically so as to average the gain variation caused due to impedance variation of the elements 72 and 73 with respect to time, the actual characteristic can be brought closer to the ideal characteristic of “Vout=2Vin”.

In the equations (7) and (8), the error voltage e of the D/A converter circuit 10 and the offset voltage d of the differential amplifier 71 are not taken into consideration for simplifying the description. However, the error voltage e of the D/A converter circuit 10 and the offset voltage d of the differential amplifier 71 will be taken into consideration in the following description. A state in which the first switching circuit is in the A state, the switching circuit 80 is in the α state, and the polarity of the pixel is positive is expressed as “Aα+”, a state in which the first switching circuit is in the B state, the switching circuit 80 is in the β state, and the polarity of the pixel is negative is expressed as “Bβ−”, a state in which the first switching circuit is in the B state, the switching circuit 80 is in the β state, and the polarity of the pixel is positive is expressed as “Bβ+”, and a state in which the first switching circuit is in the A state, the switching circuit 80 is in the α state, and the polarity of the pixel is negative is expressed as “Aα−”. Supposing that a positive-polarity voltage excluding the error voltage of the D/A converter circuit 10 and supplied to the output buffer 70 is “Vp”, a negative-polarity voltage is “Vn”, an output voltage outputted from the output buffer 70 in the state “Aα+” is “Vpa”, an output voltage in the state “Bβ+” is “Vpb”, an output voltage in the state “Aα−” is “Vna”, and an output voltage in the state “Bβ−” is “Vnb”, the respective output voltages can be expressed by the following equations (9) to (12):

Vpa=(1+α)(Vp+e+d) (9)

Vpb=(1+β)(Vp−e+d) (10)

Vna=(1+α)(Vn+e+d) (11)

Vnb=(1+β)(Vn−e+d) (12)

When the equations (9) to (12) are substituted into the equation (6) for calculating the mean voltage for four frames, the mean voltage of four frames is expressed by the following equation (13) in which there is no term of error voltages e and d:

{(2+α+β)Vp−2Vcp+2Vcn−(2+α+β)Vn}/4 (13)

An equation for calculating an ideal mean voltage with no gain variation is obtained by substituting “α=1” and “β=1” to the equation (13), (or the equation (5)). When a difference between the mean voltage including the gain variation and the ideal mean voltage is referred to as a mean error voltage, the mean error voltage can be expressed by the following equation (14) (equation (13)—equation (5)):

Mean error voltage:

(α+β−2)(Vp−Vn)/4 (14)

It should be noted that “α+β≧2”, and “α+β=2” when there is no gain variation. However, it can be considered as “α+β>2” since there is a manufacture variation in the elements 72 and 73. For example, it is assumed that the impedances of the elements 72 and 73 vary by 10%. Since “α=1.1”, “β=1/1.1≈0.91”, and “α+β≈2.01”, the mean error voltage is “0.01×(Vp−Vn)/4”. In an intermediate gray scale, the values of Vp and Vn are close to each other, so that the mean error voltage is small. When there is a large difference between the values of Vp and Vn, the mean error voltage is large. However, the maximum mean error voltage is about ±7.5 mV, when “Vp=3 V and Vn=0 V”, or when “Vp=0 V and Vn=3 V”. According to a transmittance—voltage characteristic of the liquid crystal, there is no display unevenness generated due to the mean error voltage of about ±7.5 mV since it is in a saturated region. A combination of (Aα+, Bβ−, Bβ+, Aα−) can be applied as well as a combination of (Aβ+, Bα−, Bα+, Aβ−).

In the present invention, an element with the operation voltage of 3 V or less is referred to as a low-voltage element, an element with the operation voltage of 6 V or less is referred to as a middle-voltage element, and an element with the operation voltage of 6 V or higher is referred to as a high-voltage element. A relation among a minimum gate length L_{L} of an MOS transistor of the low-voltage element, a minimum gate length L_{M} of an MOS transistor of the middle-voltage element, and a minimum gate length L_{H} of an MOS transistor of the high-voltage element is “L_{L}<L_{M}<L_{H}”. Further, a relation among an oxide film thickness ToxL of the MOS transistor as the low-voltage element, an oxide film thickness ToxM of the MOS transistor as the middle-voltage element, and an oxide film thickness width ToxH of the MOS transistor as the high-voltage element is “ToxL<ToxM<ToxH”. As the gate length and the oxide film thickness become smaller, the driving capacity becomes larger. For achieving a same driving capability, the driver IC can be reduced in size by reducing the voltage of the element.

In the present embodiment, an operation voltage range of the D/A converter circuit 10 can be made to be a half of an operation voltage range of the output buffer 70 or less. The D/A converter circuit 10 can be formed from a low-voltage element, so that the size and the consumed power can be reduced. Further, although a level shift circuit is provided between the data latch circuit 20 and the D/A converter circuit 10 in the first embodiment, it is possible to omit the level shift circuit.

Next, a voltage setting example will be shown. The D/A converter circuit 10 operates in a range of “lower power supply voltage VSS1=0 V and higher power supply voltage VDD1=3 V”. The output buffer 70 operates in a range of “lower power supply voltage VSS2=0 V and higher power supply voltage VDD2=6 V”. The output buffer 70 may also operates in “VSS2≦VSS1 and VDD2≧2×VDD1”, as long as the voltage does not exceed a break-down voltage of each element of the output buffer 70.

When the elements 72 and 73 are the capacitive elements, the capacitive elements are initialized. A switch 96 is provided between an inversion input terminal and a reference voltage line. Initialization of the capacitive elements is performed once per one frame in a vertical blanking period. At the time of initialization, an initialization signal is activated, and the output switch 19 is turned OFF. Subsequently, the switches 81 and 82 are turned OFF, the switches 85 and 96 are turned ON, and the voltages at the both ends of each capacitance are set to the reference voltage so as to discharge the electric charge of the capacitance to zero. When the initialization of the capacitance is performed simultaneously to all the outputs, the error voltage becomes extensive since noise due to the switching is large. Therefore, it is preferable to perform the initialization in order for every three or six outputs in accordance with sampling signals from a shift register circuit.

### Third Embodiment

In a third embodiment, the dot inversion drive and the column inversion drive is performed by using the circuit in the second embodiment. A fixed voltage is supplied as “Vcom”, and the data line driving circuit 3 drives in such a manner that the polarities of the adjacent data lines are different from each other.

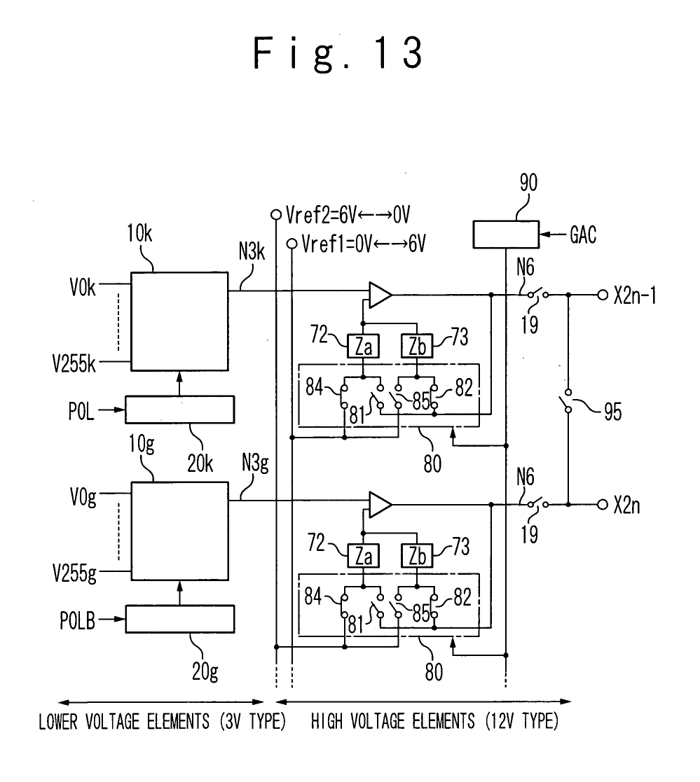

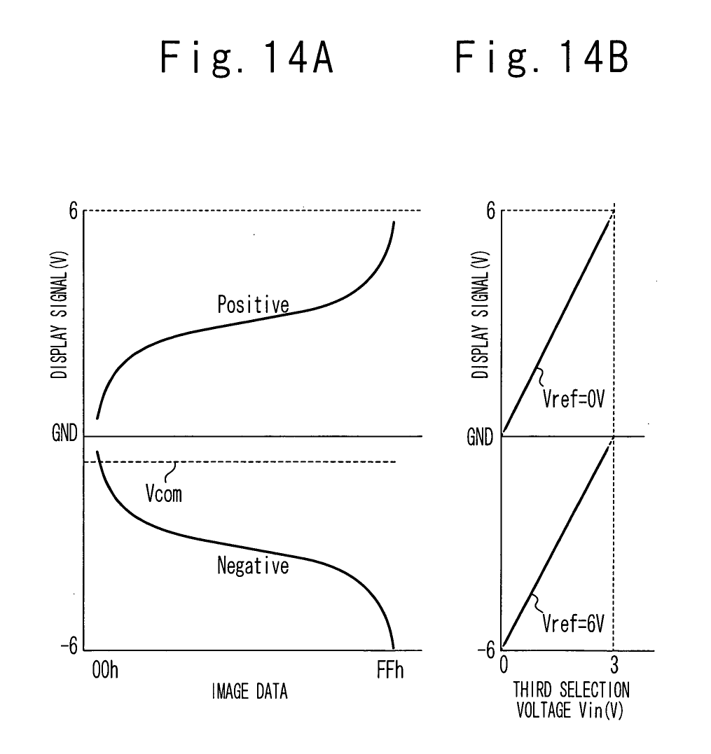

The description will be made with reference to FIGS. 13 and 14A and 14B. In the dot inversion drive, a polarity signal POL is inverted for every scanning line and every frame. In the column inversion drive, the polarity signal POL is inverted for every frame. An odd-numbered output terminal X2n−1 and an even-numbered output terminal X2n output voltages of different polarities. A reference voltage line for the D/A converter circuit 10 to the odd-numbered output terminal X2n−1 has a first reference voltage Vref1, and a reference voltage line for the D/A converter circuit 10 to the even-numbered output terminal X2n has a second reference voltage Vref2. Different voltages are supplied thereto. For example, in a first period (POL=L), the voltages of “Vref1=0 V” and “Vref2=6 V” are supplied. In a second period (POL=L), the voltages of “Vref1=6 V” and “Vref2=0 V” are supplied. Supposing that the input/output characteristic of the output buffer 70 is ideal and “Za=Zb”, and that “Vref=0 V” in the output of a positive polarity voltage and “Vref=6 V” in the output of a negative polarity voltage, the following equations (15) and (16) can be obtained:

Positive polarity: Vout=2Vin (15)

Negative polarity: Vout=2Vin−6 (16)

Gradation wirings (V0k-V255k) for the odd-numbered output terminal are connected to the first selecting circuit 16 for an odd-numbered D/A converter circuit 10k. Further, gradation wirings (V0g-V255g) for the even-numbered output terminal are connected to the first selecting circuit 16 for an even-numbered D/A converter circuit 10g.

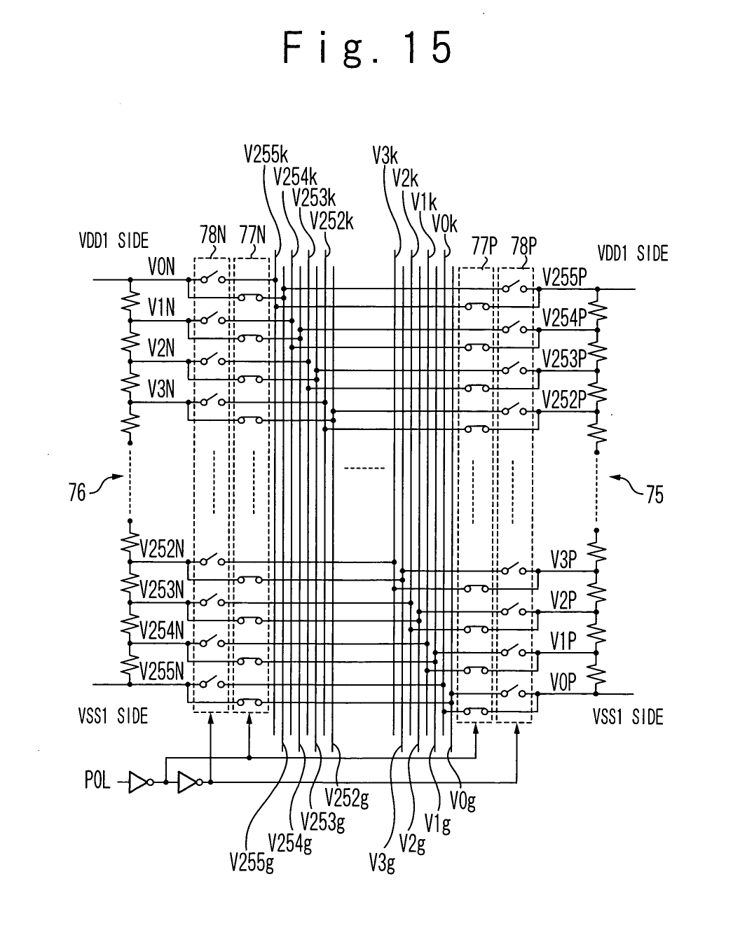

FIG. 15 shows details of the gradation voltage generating circuit. Gamma correction for the positive polarity voltage and gamma correction for the negative polarity voltage are slightly different, so that a positive-polarity gamma generating section 75 and a negative-polarity gamma generating section 76 are provided. The positive-polarity gamma generating section 75 includes a plurality of resistances and switch groups 77P and 78P, and generates a plurality of voltages having a relation of “VSS1≦V0P<V1P< . . . <V254P<V255P≦VDD1”. The negative-polarity gamma generating section 76 includes a plurality of resistances and switch groups 77N and 78N, and generates a plurality of voltages having a relation of “VSS1≦V255N<V254N< . . . <V1N<V0N≦VDD1”.

When the polarity signal POL is in the high level, voltages on the gradation wirings for the odd-numbered output terminal become “V0k=V0P, V1k=V1P, . . . , V254k=V254P, V255k=V255P” in a state of the switches (the switches 77P and 77N are in the ON state and the switches 78P and 78N are in the OFF state) shown in FIG. 15. Also, voltages on the gradation wirings for the even-numbered output terminal become “V0g=V255N, V1g=V254N, . . . , V254g=V1N, V255g=V0N”. When the polarity signal POL is in the low level, voltages on the gradation wirings of the odd-numbered output terminal become “V0k=V255N, V1k=V254N, . . . , V254k=V1N, V255k=V0N” in a state of the switches (the switches 77P and 77N are in the OFF state and the switches 78P and 78N are in the ON state) that is opposite to the state shown in FIG. 15. Also, voltages on the gradation wirings for the even-numbered output terminal become “V0g=V0P, V1g=V1P, . . . , V254g=V254P, V255g=V255P”. Paying attention to the gradation wiring V0k, either of “V0P” and “V255N” is supplied. “V0P” and “V255N” are close voltages on the VSS1 side, so that a switch of the first selecting circuit 16 to which “V0k” is connected can be formed from an N-channel transistor. Similarly, paying attention to the gradation wiring V255k, either of “V255P” and “V0N” is supplied. “V255P” and “V0N” are close voltages on a VDD1 side, so that a switch of the first selecting circuit 16 to which “V255k” is connected can be formed from a P-channel transistor. Therefore, it is possible to reduce a size of the first selecting circuit 16 by forming the switches connected to the wirings V0k-V128k and V0g-V128g from the n-channel transistors and forming the switches connected to the wirings V132k-V255k and V132g-V255g from the p-channel transistors.

For realizing the first selecting circuit 16 of a small size, the data latch circuit 20 (20k or 20g) inverts the data in accordance with the polarity signal POL. The polarity signal POL is supplied to the data latch circuit 20k for the odd-numbered output terminal, and a signal POLB obtained by inverting the polarity signal POL is supplied to the data latch circuit 20g for the even-numbered output terminal. When the polarity signal POL is in the high level, image data latched by the data latch circuit 20k for the odd-numbered output terminal is outputted to the D/A converter circuit 10k without being inverted. Image data latched by the data latch circuit 20g for the even-numbered output terminal is outputted to the D/A converter circuit 10g after being inverted. When the polarity signal POL is in the low level, image data latched by the data latch circuit 20k for the odd-numbered output terminal is outputted to the D/A converter circuit 10k after being inverted. Image data latched by the data latch circuit 20g for the even-numbered output terminal is outputted to the D/A converter circuit 10g without being inverted.

Assuming that the image data is “00h”, when the polarity signal POL is in the high level, the image data is not inverted by the D/A converter circuit 10k (remains as “00h”), and the voltage (V0P) of V0k is outputted to a third node N3k. The image data is inverted to “FFh” by the D/A converter circuit 10g, and the voltage (V0N) of V255g is outputted to a third node N3g. When the polarity signal POL is in the low level, the image data is inverted to “FFh” by the D/A converter circuit 10k, and the voltage (V0N) of V255k is selected. The image data is not inverted (remains as “00h”) by the D/A converter circuit 10g, and the voltage (V0P) of V0g is selected.

As in the second embodiment, the gradation voltages supplied to the pixels are averaged with respect to time by using four frames as one cycle. A relation of the A state and B state in the offset voltage switching operation of the first buffer 11 and the second buffer 12, and the state a and the state β in the gain changing operation of the output buffer 70 is preferable to be in (Aα+, Bβ−, Bβ+, Aα−) or (Aβ+, Bα−, Bα+, Aβ−), as in the second embodiment.

Supposing that the error voltage of the D/A converter circuit 10 is “e”, the offset voltage of the differential amplifier 71 is “d”, “α=Zb/Za”, “β=Za/Zb”, the positive-polarity input voltage excluding the error voltage of the D/A converter circuit 10 and supplied to the output buffer 70 is “Vp”, and the negative-polarity input voltage is “Vn”, the output voltages outputted from the output buffer 70 can be expressed by the following equations (17) to (20):

Positive polarity a:

Vpa=(1+α)(Vp+e+d)−αVref1 (17)

Positive polarity b:

Vpb=(1+β)(Vp−e+d)−βVref1 (18)

Negative polarity a:

Vna=(1+α)(Vn+e+d)−αVref2 (19)

Negative polarity b:

Vnb=(1+β)(Vn−e+d)−βVref2 (20)

A mean voltage when one cycle is composed of four frames is expressed by the equation (6). Since “Vcn=Vcp” in the equation (6) when a common voltage is fixed, the mean voltage over the four frames can be expressed by the following equation (21):

(Vpa+Vpb−Vna−Vnb)/4 (21)

When the equations (17) to (20) are substituted to the equation (21), the mean voltage of four frames is expressed by the following equation (22) in which there is no term of error voltages e and d:

{(α+β+2)Vp−(α+β)Vref1−(α+β+2)Vn+(α+β)Vref2}/4 (22)

A mean error voltage between an ideal mean output voltage with no error voltage and a mean output voltage outputted from the output buffer 70 can be expressed by the following equation (23):

Mean error voltage:

(α+β−2)(Vp−Vn−Vref1+Vref2)/4 (23)

Compared with the equation (14), terms of the reference voltages (Vref1, Vref2) are added, so that the mean error voltage is larger than in the line inversion drive. Display unevenness in middle gradation is easily visible, and display unevenness comes to be recognizable in the output voltage variation of about ±5 mV. Therefore, it is preferable to keep the mean error voltage to be 5 mV or less. In the middle gradation, “Vp≈Vn”. Thus, the mean error voltage in the middle gradation is almost equivalent to “(α+β−2) (Vref1−Vref2)/4”. For controlling the mean error voltage to be 5 mV or less when “Vref1=0 V and Vref2=6 V”, a relative variation of the impedances of the elements 72 and 73 is sufficient to be suppressed to be about 6% or less. In a linear region, “Vp−Vn” is about 2V at the maximum. Thus, for controlling the mean error voltage to be 5 mV or less in the linear region, the relative variation of the impedances of the elements 72 and 73 needs to be suppressed to be about 5% or less.

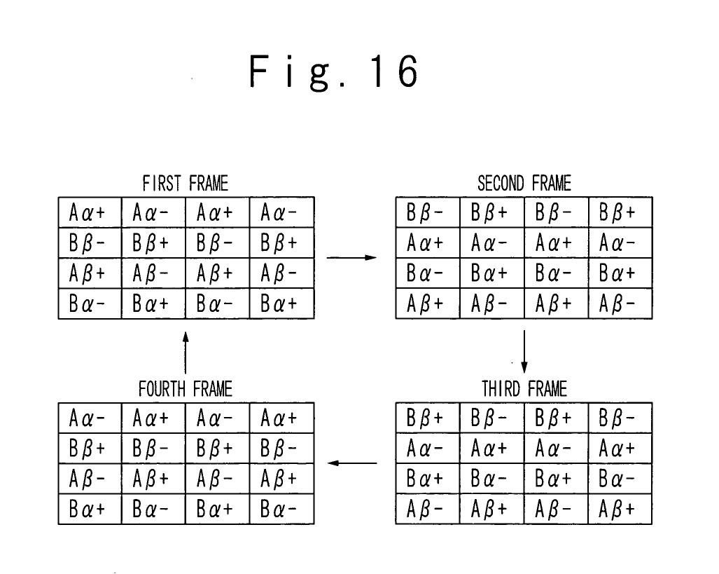

FIG. 16 schematically shows the polarities of pixels, the polarities of an offset voltage, and a gain switching state in case of the dot inversion drive. Each of the pixels is driven as in (Aα+, Bβ−, Bβ+, Aα−) or (Aβ+, Bα−, Bα+, Aβ−). A gain control signal GAC is preferable to be inverted for every two scanning lines and every two frames. Through dispersing the error voltages spatially, flicker can be made harder to be recognized. In the first embodiment, flicker tends to be generated in a lateral stripe pattern since the line inversion drive is employed. Thus, the polarity of the offset voltage is inverted for every two scanning lines. However, the dot inversion drive is competent to a flicker of the lateral stripe pattern. Therefore, when an error voltage of the output buffer 70 due to a gain variation is larger than the offset voltages of the first buffer 11 and the second buffer 12, the signal OFC may be inverted for every one scanning line and every two frames.

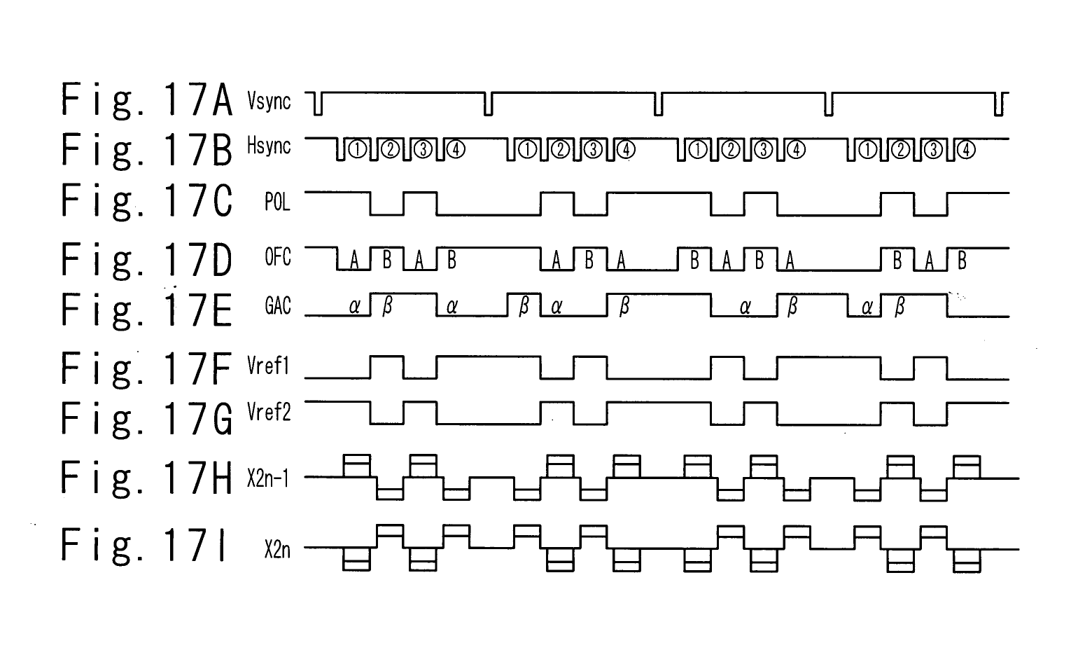

FIGS. 17A to 17I are timing charts of various signals in the state shown in FIG. 16. The description will be provided, supposing that there are four scanning lines. The signal OFC is inverted for every one scanning line and every two frames. The signal GAC is inverted for every two scanning lines and every two frames. The polarity signal POL is inverted for every one scanning line and for every one frame. The reference voltage Vref1 and the reference voltage Vref2 are inverted in accordance with the polarity signal POL, so that those reference voltages are inverted for every one scanning line and every one frame. However, it should be noted that “Vref1” and “Vref2” are different from each other, as described above.

Before inverting the polarities of the data lines, the adjacent data lines are short-circuited temporarily so as to neutralize (collect) electric charges. The electric charges are collected by turning OFF the output switches 19 and turning ON a short switch 95.

The signal GAC and the signal OFC can be controlled individually, and can be driven in states other than states shown in FIG. 16. For example, each pixel may be driven only in a combination of elements (Aα+, Bβ−, Bβ+, Aα−) or only in a combination of elements (Aβ+, Bα−, Bα+, Aβ−).

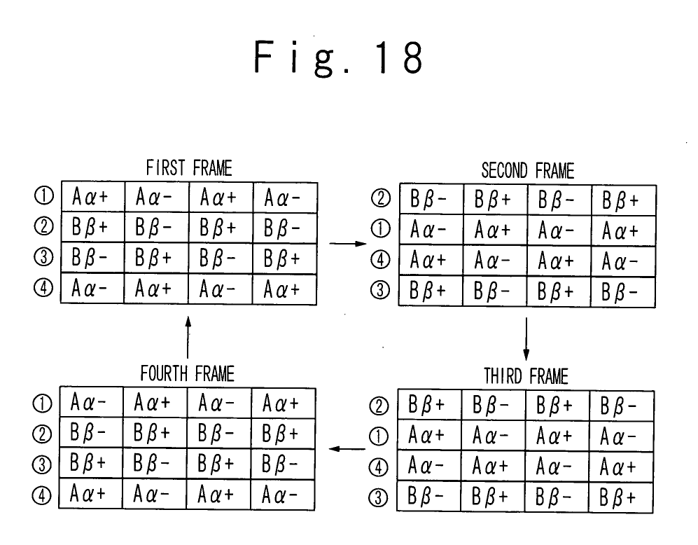

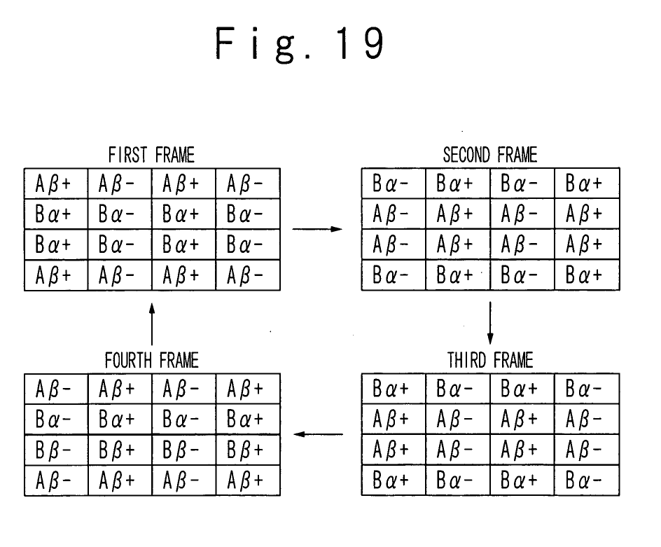

FIG. 18 is a schematic diagram of a 2H dot inversion drive, and FIG. 19 is a schematic diagram of a column inversion drive. As described above, the polarity signal POL, the signal OFC, and the signal GAC can be controlled individually. Thus, it is possible to control these signals at timings other than those shown in the diagrams. However, there are combinations in which the error voltages are not cancelled. Therefore, it is preferable to select the combinations in which the error voltages are cancelled.

In the 2H dot inversion drive shown in FIG. 18, it is preferable to oppose the order of driving the scanning lines for every two frames. The order of driving the scanning lines is a normal scanning order, i.e., “first scanning line—second scanning line—third scanning line—fourth scanning line”, and an opposed scanning order, i.e., “second scanning line—first scanning line—fourth scanning line—third scanning line”, by opposing the scanning order of the first and second scanning lines and the scanning order of the third and fourth scanning lines. The signal OFC and the signal GAC may be inverted for every two scanning lines regardless of the frames.

According to the third embodiment, the D/A converter circuit 10 is formed from the low-voltage elements, and the output buffer 70 is formed from the high-voltage elements. By reducing the voltage of the D/A converter circuit 10, the size and consumed power of the circuit 10 can be reduced. Subsequently, a voltage setting example will be shown. The D/A converter circuit 10 operates in “lower power supply voltage VSS1=0 V and higher power supply voltage VDD1=3 V”. The output buffer 70 and a second control circuit 90 operate in “the lower power supply voltage VSS2=−6 V or higher and the higher power supply voltage VDD2=6 V or higher”.

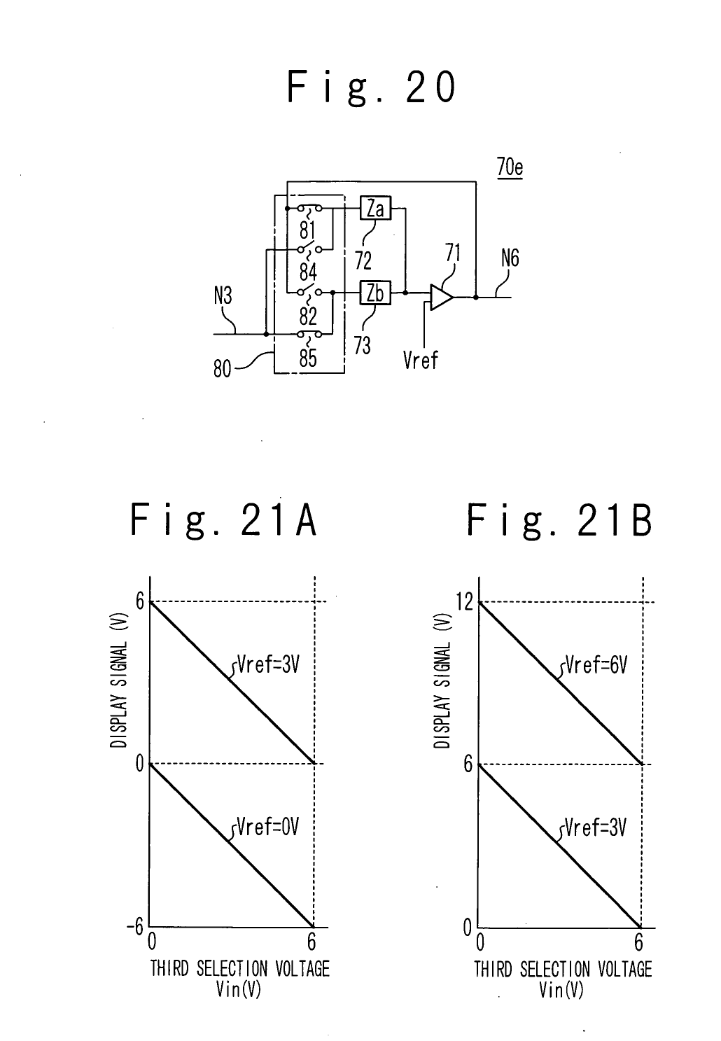

The case that the ideal gain of the output buffer 70 is “2” has been described above. However, in a circuit configuration shown in FIG. 20, the ideal gain may also be “−1”.

A connection relation when the ideal gain is “−1” will be described. The non-inversion input terminal of the differential amplifier 71 is connected to the reference voltage line Vref. The inversion input terminal of the differential amplifier 71 is connected to one end of each of the elements 72 and 73. The switch 81 and the switch 82 are respectively provided between the other end of each of the elements 72 and 73 and the output terminal N6 of the differential amplifier 71. Further, the switch 84 and the switch 85 are respectively provided between the other end of each of the elements 72 and 73 and the third node N3.

The input/output characteristic in the circuit configuration of FIG. 20 can be expressed by the following equations (24) and (25). It should be noted that “α=Zb/Za” and “β=Za/Zb”.

Vout=−αVin+(1+α)Vref (24)

Vout=−βVin+(1+β)Vref (25)

Referring to FIG. 21A, assuming that an input voltage range is from 0 V to 6 V, “Vref=3 V” in the positive polarity, and “Vref=0 V” in the negative polarity, an output voltage range is from −6 V to 6 V. The power supply voltages of the output buffer 70 are the lower voltage VSS2 of −6 V or less and the higher voltage VDD2 of 6 V or higher. Referring to FIG. 21B, assuming that the input voltage range is from 0 V to 6 V, “Vref=6 V” in the positive polarity, and “Vref=3 V” in the negative polarity, the output voltage range is from 0 V to 12 V. The power supply voltages of the output buffer 70 are the lower voltage VSS2 of 0 V or less and the higher voltage VDD2 of 12 V or higher.

The following equation (26) is obtained when the mean error voltage can be calculated as in the ideal gain is “2”.

Mean error voltage:

(α+β−2)(Vp−Vn+Vref1−Vref2)/4 (26)

In the middle gradation, “Vn≈Vp”. Thus, the mean error voltage in the middle gradation is almost equivalent to “(α+β−2)(Vref1−Vref2)/4”. In the equation (23), a voltage difference between “Vref1” and “Vref2” is 6 V. However, the difference voltage between “Vref1” and “Vref2” is 3 V that is one half of 6 V, when the ideal gain is “−1”. Thus, the mean error voltage in the middle gradation is reduced to a half, compared to the case that the ideal gain is “2”. However, the mean error voltage is not reduced to a half in all the regions but Vn−Vp is twice as much in the saturated region. Therefore, the mean error voltage is the same.

Since the operation voltage of the D/A converter circuit 10 becomes higher, the consumed power is increased compared to a case of the circuit configuration with the ideal gain “2”. Further, there is such a disadvantage that a chip size of the driver IC becomes larger. In this circuit configuration, however, it is possible to change a range of the power supply voltage depending on an application field. Therefore, there is such an advantage that the convenience can be improved. For example, batteries of portable telephones are of 3 V or less in many cases, and voltages necessary for driving are generated in a power supply circuit built-in to the driver IC. In case of using a charge-pump type, efficiency of changing “3 V” to “6 V” or “−6 V” is better than the power efficiency that changes “3 V” to “6 V” and “12 V”. Further, in a large-sized display panel, the power supply voltage is supplied from the outside the driver IC and the power supply voltage supplied to the display apparatus is DC 12 V in many cases. Thus, the power efficiency can be improved by directly using the power supply voltage.

The second and third embodiments are described with reference to the case of having tow elements as the elements 72 and 73. However, there may be three elements as the plurality of elements. In case of the three elements, the ideal gain can be made as “3” or “−2”. The output voltages are averaged with respect to time by having six frames as one cycle. In the numbers of elements is n, the ideal gain is “n” or “−(n−1)”, and “2×n” frames may be taken as one cycle.

### Fourth Embodiment

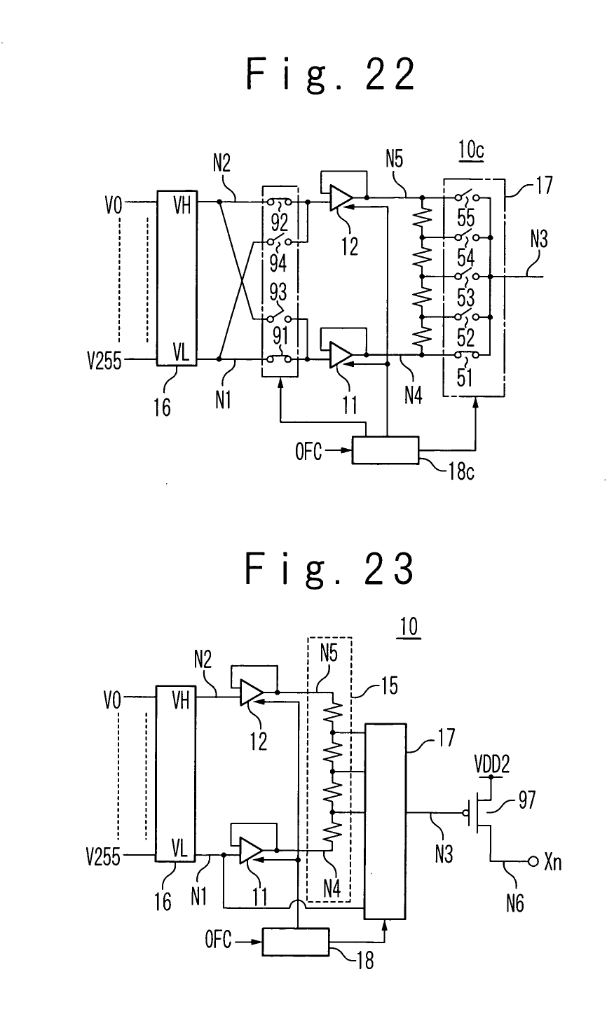

In the first to third embodiments, the first switching circuit for inverting the polarities of the offset voltages is provided inside the buffer 11 and inside the second buffer 12. However, in a D/A converter circuit 10c according to a fourth embodiment of the present invention, the first switching circuit may be provided between the first buffer 11 and the second buffer 12 (FIG. 22). In the first switching circuit, a switch 91 is provided between the first node N1 and the first buffer 11, a switch 92 is provided between the second node N2 and the second buffer 12, a switch 93 is provided between the second node N2 and the first buffer 11, and a switch 94 is provided between the first node N1 and the second buffer 12.

When the signal OFC is in the low level (A state), the switches 91 and 92 are turned ON, and the switches 93 and 94 are turned OFF. When the signal OFC is in the high level (B state), the switches 91 and 92 are turned OFF, and switches 93 and 94 are turned ON. Supposing that the offset voltage of the first buffer 11 is “+e1” and the offset voltage of the second buffer 12 is “+e2”, the first selection voltage VL is supplied to the first buffer 11 in the A state, and the output voltage is “VL+e1”, while the second selection voltage VH is supplied to the second buffer 12, and the output voltage is “VH+e2”. The second selection voltage VH is supplied to the first buffer 11 in the B state, and the output voltage is “VH+e1”, while the first selection voltage VL is supplied to the second buffer 12, and the output voltage is “VL+e2”. That is, provided that the buffer to which the first selection voltage VL is supplied is the first buffer and the buffer to which the second selection voltage VH is supplied is the second buffer, the offset voltage of the first buffer changes from +e1 to +e2, and the offset voltage of the second buffer changes from +e2 to +e1.

In the D/A converter 10 used in the first to third embodiments, the interpolation voltages have the ideal voltage values by inverting the polarities of the offset voltages of the buffers. However, in the fourth embodiment, the interpolation voltages have the error voltage of “(e1+e2)/2” with respect to the ideal voltages. Since there is a possibility of loosing the monotonous increase characteristic when the first node N1 and the third node N3 are directly connected, a switch 55 is provided additionally.

The switch to be selected by the second selecting circuit 17 varies depending on the signal OFC. When the signal OFC is in the low level (A state), the switch 51 is turned ON when the two lower bits are “00”, the switch 52 is turned ON when the two lower bits are “01”, the switch 53 is turned ON when the two lower bits are “10”, and the switch 54 is turned ON when the two lower bits are “11”. When the signal OFC is in the high level (B state), the switch 55 is turned ON when the two lower bits are “00”, the switch 54 is turned ON when the two lower bits are “01”, the switch 53 is turned ON when the two lower bits are “10”, and the switch 52 is turned ON when the two lower bits are “11”. The second buffer 12 is inactivated when the signal OFC is in the low level (A state) and the two lower bits are “00”, and the first buffer 11 is inactivated when the signal OFC is in the high level (B state) and the two lower bits are “00”, in order to shut off the electric current flowing through the resistance string circuit 15.

An advantage of this circuit is in that the number of elements for the first switching circuit can be reduced. However, it is a disadvantage of this circuit that a logic circuit of a first control circuit 18 becomes complicated, since the switch 55 as well as the elements for the first buffer 11 and the second buffer 12 need to be provided additionally for forming the first buffer 11 and the second buffer 12 to be normal amplifiers that can boost up and reduce the voltages. There is also a disadvantage of increasing the consumed power, since both of the first buffer 11 and the second buffer 12 cannot be inactivated at the same time.

### Fifth Embodiment

The output buffer including a differential amplifier is provided for the third output node N3 of the D/A converter circuit 10. However, it may be a MOS transistor, which generates a gradation current in accordance with the voltage selected by the second selecting circuit. This is used for an organic EL, which is a current-drive type display panel (FIG. 23).

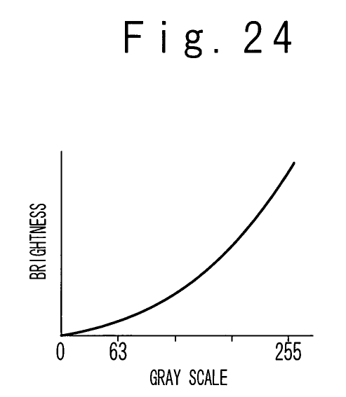

FIG. 24 shows a luminance-gradation characteristic of the organic EL. In a low-luminance region, it is preferable to output the voltage of the first node N1 directly to the third node N3. Whether it is a low-luminance region or not is determined according to higher K bits including the most significant bit. For example, when the two higher bits are “00” (0-63 gradations), the switch 51 is turned ON to output the voltage directly to the third node N3. For 64-255 gradations, the interpolation voltages are used.

The first to fifth embodiments have been described with reference to the case using the image data of eight bits. However, the image data may be of nine bits or more (FIG. 25). Hereinafter, a case of the image data of ten bits will be described. In the image data of ten bits (D9 (MSB)—D0 (LSB)), for example, a control is performed based on (8+2) bits in the regions I and III, and based on (6+4) bits in the region II. Here, the number of switches of the second selecting circuit is sixteen (2⁴=16). The first control circuit inactivates the first buffer 11 and the second buffer 12 when the three higher bits (D9, D8, D7) including the most significant bit are “000” or “111” and the two lower bits (D1, D0) including the least significant bit are “00”, or when the three higher bits (D9, D8, D7) are other than “000” and “111”, and the four lower bits (D3, D2, D1, D0) including the least significant bit are “0000”.

The number of voltages generated by the gradation voltage generating circuit becomes double. However, the control may be performed based on (9+1) bits in the regions I and III, and based on (7+3) bits in the region II. The number of switches of the second selecting circuit is eight (2³=8). The first control circuit inactivates the first buffer 11 and the second buffer 12 when the three lower bits including the least significant bit are “000”.

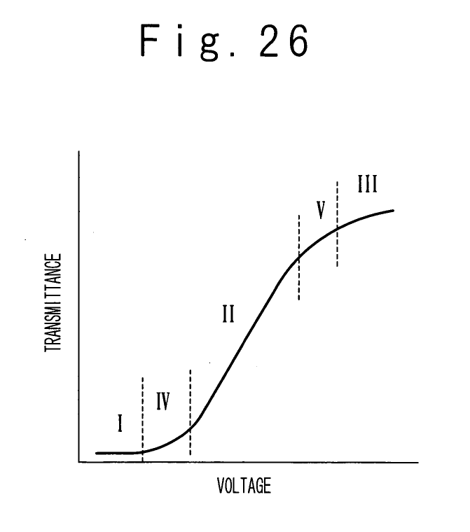

As shown in FIG. 26, the region I may be divided further into the regions I and IV, and the region III may be divided further into the regions III and V, and the controls may be performed based on 10 bits in the regions I and III, based on (8+2) bits in the regions IV and V, and based on (6+4) bits in the region II. Here, it is determined as the region I when the four higher bits including the most significant bit are “0000”, determined as the region IV when “0001”, determined as the region V when “1110”, determined as the region III when “1111”, and determined as the region II for other cases. The first control circuit inactivates the first buffer 11 and the second buffer 12 when the four lower bits including the least significant bit are “0000” or when the data of the four higher bits including the most significant bits are “0000” or “1111”.

Further, in the first to fifth embodiments described above, even if the buffers of a gradation voltage generating circuit have the offset voltages as in case of the offset voltages of the buffers 11 and 12 of the D/A converter circuit, it is possible to average the unevenness with respect to time on the display to obtain a fine picture quality by switching the polarities of the offset voltages. Now, the aforementioned D/A converter circuit will be described with reference to a case of using two ICs. Each of the two ICs (to be referred to as a master IC3m and a slave IC3s hereinafter) includes a gradation voltage generating circuit 150. It should be noted that the gradation voltage generating circuit of the master IC3m is referred to as a master gradation voltage generating circuit 150m, and the gradation voltage generating circuit of the slave IC3s is referred to as a slave gradation voltage generating circuit 150s. “Master” or “slave” is set by an M/S input terminal.

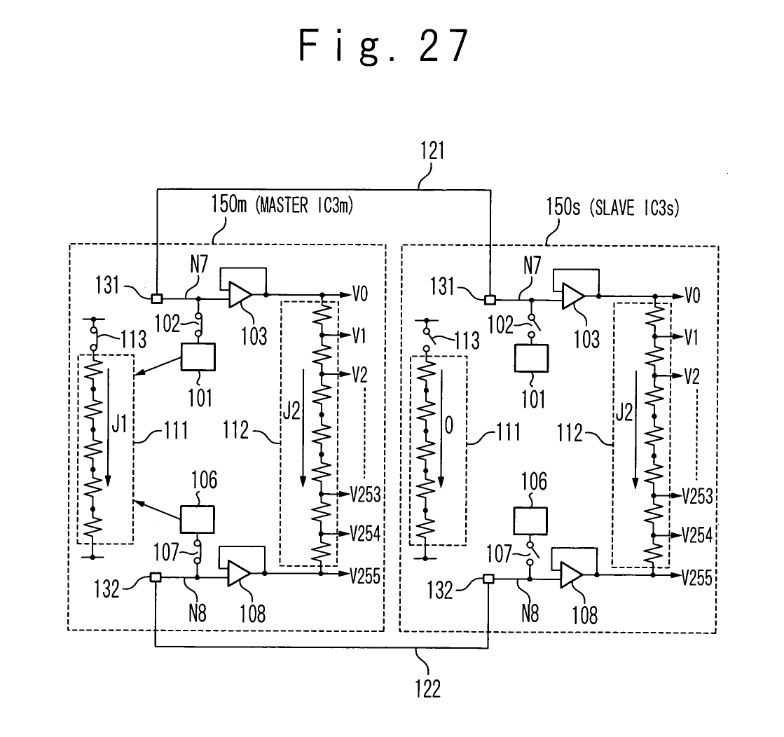

FIG. 27 shows an example of a circuit configuration of the gradation voltage generating circuit 150, and details thereof will be described. A resistance string 111 and a switch 113 are connected in series between a lower power supply voltage and a higher power supply voltage. In a master setting, the switch 113 is turned ON. In a slave setting, the switch 113 is turned OFF to shut off an electric current flowing through the resistance string 111 so as to reduce the consumed power. In FIG. 25, the switch 113 is provided between the higher power supply voltage and the resistance string 111. However, the switch 113 may be provided between the lower power supply voltage and the resistance string 111.

Each of reference voltage setting circuits 101 and 106 selects one from one of the voltages divided by the resistance string 111, the higher supply voltage, and the lower supply voltage based on setting information. One end of a switch 102 is connected to the reference voltage setting circuit 101 that generates the reference voltage of V0, and the other end of the switch 102 is connected to an input node of a buffer 103 and an input/output terminal 131. It should be noted that an input impedance of the buffer 103 is extremely large.

Like the circuit for the voltage V0, a circuit for generating the reference voltage of V255 has a switch 107, which is connected at one end to the reference voltage setting circuit 106, and is connected at the other end to an input node of a buffer 108 and an input/output terminal 132. It should be noted that the input impedance of the buffer 108 is extremely large. Ideally, it is preferable for the input impedances of the buffers 103 and 108 to be infinite.

For the master gradation voltage generating circuit 150m and the slave gradation voltage generating circuit 150s, there is a difference in a part of their operations. Setting information of reference voltages of V0 and V255 is supplied to the master IC3m, whereas setting information of the reference voltages is not supplied to the slave IC3s. However, the reference voltages generated by the master IC3m are supplied to the slave IC3s as the reference voltages. In the master gradation voltage generating circuit 150m, the switches 102, 107, and 113 are turned ON. In the slave gradation voltage generating circuit 150s, the switches 102, 107, and 113 are turned OFF.

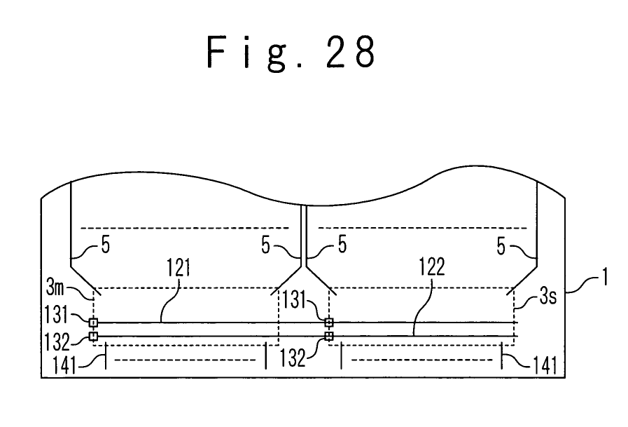

The input/output terminal 131 of the master IC3m and the input/output terminal 131 of the slave IC3s, as well as the input/output terminal 132 of the master IC3m and the input/output terminal 132 of the slave IC3s are connected, respectively, via external wirings. For example, these terminals are connected via a wiring 121 and a wiring 122 on a substrate 1 shown in FIG. 28. The reference voltages generated by the master gradation voltage generating circuit 150m are also supplied to the buffer of the slave IC3s.

In an actual mounting, a bump of the input/output terminal 131 of the IC is connected onto a substrate 1 via an anisotropic conductive film ACF, to provide a high connection resistance. Thus, when the electric current flows, the reference voltages of the master gradation voltage generating circuit 150m becomes different from those of the slave gradation voltage generating circuit 150s due to a voltage drop. However, because the buffers 103 and 108 with the extremely large input impedances are provided between the reference voltage setting circuits 101 and 106 and the resistance string 112, no electric current flows to the routes of the node N7 and the node N8. As a result, no voltage drop occurs due to the connection resistance, even though block unevenness is generated due to the offset voltages of the buffers 103 and 108. However, the block unevenness can be improved by inverting the polarities of the offset voltages of the buffers 103 and 108 as in the case of the D/A converter circuit 10 described above.

The explanations are provided above with reference to the case of two reference voltages. However, three to seven intermediate reference voltages are provided further for correcting a resistance variation of the resistance string 112. Five to nine reference voltages are necessary at the minimum. With the dot inversion drive, positive-polarity and negative-polarity reference voltages are provided. Thus, it is necessary to have double number of reference voltages, i.e., ten to eighteen reference voltages.

The above description has been made with reference to a case that the driving circuits are integrated on a semiconductor chip. However, the driving circuits of the present invention can also be integrated on the display panel 1 where the pixels are formed.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A driving circuit for a display apparatus, comprising:
a first selecting circuit configured a to select two voltages from a plurality of voltages based on a image data to output to a first node as a first selection voltage and to a second node as a second selection voltage;
a first buffer configured to receive the first selection voltage;
a second buffer configured to receive the second selection voltage;
a voltage dividing circuit configured to generate a plurality of interpolation voltages between an output voltage of said first buffer and an output voltage of said second buffer;
a second selecting circuit configured to select one voltage from the first selection voltage and the plurality of interpolation voltages based on a part of the image data, to output to a third node as a third selection voltage; and
a first control circuit configured to control said first buffer or said second buffer based on the part of the image data.

2. The driving circuit according to claim 1, wherein said first control circuit controls a first switching circuit in said first buffer and said second buffer to change error voltages for every predetermined period.

3. The driving circuit according to claim 1, wherein said first control circuit sets at least one of said first buffer and said second buffer to an inactive state to shunt off a current flowing through said voltage dividing circuit when the part of the image is equal to a predetermined data.

4. The driving circuit according to claim 2, wherein said first control circuit stops an operation of said first switching circuit when the part of the image is equal to a predetermined data.

5. The driving circuit according to claim 1, wherein each of said first and second buffers comprises a voltage follower circuit,
a switch of said second selecting circuit is provided between said first node and said third node, and
said first control circuit controls said switch to be turned on so as to output the first selection voltage to said third node, when the part of the image data is equal to the predetermined data.

6. The driving circuit according to claim 1, wherein an output stage of said first buffer consists of a first transistor having a sauce electrode connected with a first power supply voltage and a drain electrode connected with one of ends of said voltage dividing circuit,
an output stage of said second buffer consists of a second transistor having a sauce electrode connected with a second power supply voltage and a drain electrode connected with other end of said voltage dividing circuit, and
a value of current flowing through said first transistor, a value of current flowing through said second transistor, and a value of current flowing through said voltage dividing circuit are equal to each other in a steady state.

7. The driving circuit according to claim 1, further comprising:
a voltage follower circuit configured to receive the third selection voltage to output a gradation voltage to an output terminal.

8. The driving circuit according to claim 1, further comprising:
a MOS transistor configured to receive the third selection voltage to output a gradation voltage to an output terminal.

9. The driving circuit according to claim 1, further comprising:
an output buffer configured to receive the third selection voltage to output a gradation voltage to an output terminal,
wherein said output buffer comprises:
a switch circuit configured to connect a non-inversion input terminal of said output buffer with said third node and an inversion input terminal thereof with one of ends of each of elements, and to switch connection relation of said elements between the other end of each element and said output terminal and the other end of each element and a reference voltage, for every predetermined period.

10. The driving circuit according to claim 1, further comprising:
an output buffer configured to receive the third selection voltage to output a gradation voltage to an output terminal,
wherein said output buffer comprises:
a switch circuit configured to connect an inversion input terminal of said output buffer with a reference voltage and a non-inversion input terminal thereof with one of ends of each of elements, and to switch connection relation of said elements between the other end of each element and said output terminal and the other end of each element and said third node, for every predetermined period.

11. The driving circuit according to claim 9, wherein the reference voltage is variable for every predetermined period.

12. The driving circuit according to claim 10, wherein the reference voltage is variable for every predetermined period.

13. The driving circuit according to claim 9, wherein the reference voltage for an odd-numbered output terminal is different from the reference voltage for an even-numbered output terminal.

14. The driving circuit according to claim 10, wherein the reference voltage for an odd-numbered output terminal is different from the reference voltage for an even-numbered output terminal.

15. The driving circuit according to claim 9, wherein said elements are resistance elements, and have a same designed resistance value.

16. The driving circuit according to claim 10, wherein said elements are resistance elements, and have a same designed resistance value.

17. The driving circuit according to claim 9, wherein said elements are capacitance elements, and have a same designed capacitance value.

18. The driving circuit according to claim 10, wherein said elements are capacitance elements, and have a same designed capacitance value.

19. The driving circuit according to claim 17, wherein said capacitance elements are sequentially initialized in response to an initialization signal and a signal outputted from a shift register circuit.

20. The driving circuit according to claim 2, wherein said first control circuit controls said first switching circuit in said first buffer and said second buffer such that polarities of the error voltages of said first and second buffers are different from each other.
